(19) United States
(12) Patent Application Publication
(10) Pub. No.: US 2009/0037336 A1
(43) Pub. Date: Feb. 5, 2009

(54) LICENSE MANAGEMENT SYSTEM AND LICENSE MANAGEMENT METHOD

(75) Inventor: Jin Sunata, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/182,416

(22) Filed: Jul. 30, 2008

(30) Foreign Application Priority Data
Aug. 1, 2007 (JP) 2007-201213(PAT.)

(51) Int. Cl. H04L 9/00

(52) U.S. Cl. 705/59

(57) ABSTRACT

A device managing server is configured to generate, in the case of a device causing an error, device-unavailable information including the operation status of the device thereof, and a license information issuance server is configured to obtain the compensation worth of a license based on the device-unavailable information in the case of determining that the device cannot be used regarding which the user cannot be faulted.

### BACKGROUND OF THE INVENTION

1. Field of the Invention

The present invention relates to a license management system, license management method, and computer program, and is particularly suitable for operating an electronic device based on a license.

2. Description of the Related Art

Heretofore, as an arrangement wherein an option function is added to an electronic device such as a printing apparatus, and so forth, various arrangements are employed such as an arrangement wherein an option function is added to an electronic device at the time of manufacturing, and an arrangement wherein a user purchases a product for realizing an option function separately, and adds the option function to an electronic device at home. Also, there is a method wherein at least one option function is installed in an electronic device beforehand, and for example, in the case a user also purchasing an option function at the time of purchasing the electronic device, the user can use the option function installed in the electronic device by setting a license key to the electronic device.

It is not desirable that this license key can be copied and employed for the same type of electronic devices. Accordingly, the license key needs to be unique for each electronic device. At the time of employing such a license key and adding an option function to an electronic device, the electronic device issues a license in exchange for information unique to the electronic device serving as an object to which the option function is installed. Thus, heretofore, illegal use of an option function (software) for an electronic device other than the electronic device serving as an object to be installed has been prevented.

Also, as for a method for controlling a license at an electronic device, a technique has also been known wherein heretofore, a response is performed as to a request for employing a licensed software program, thereby adding an option function to an electronic device. Further, a technique has been proposed wherein a license is employed, and the license is extended, or its license mode is modified. Also, a technique has also been proposed wherein the extension, updating, and modification of a license are automatically performed by remote control. Also, a technique has been proposed wherein the circulation of a digital content is monitored, management is performed regarding how often the content is used by communication, thereby realizing modification of a license use condition document, or a combination of multiple license use condition documents (e.g., see Japanese Patent Laid-Open No. 2006-4194).

Note however, with the related art, after issuance of a license, the value of the license to be provided originally has been frequently lessened by failure of an electronic device or the like. For example, let us say that there has been a license available until a certain month of a certain year, but a user could not use an electronic device for one week due to occurrence of a component failure. In this case, the use limit might have expired with the period when the electronic device could not be used due to the failure of the electronic device included, in some cases. Also, for example, let us say that there has been a license whereby printing of 100 sheets can be employed. In this case, there has been a possibility that sheets will be wasted by jamming due to frequent occurrence of a sheet conveyance trouble or electronic device error.

Under such an assumption, the original period and frequency values of the license have sometimes been lessened depending on a case wherein the function cannot be used for a certain period of time owing to a printing failure due to frequent occurrence of jamming, or an electronic device error due to a component failure.

### SUMMARY OF THE INVENTION

According to a first aspect of the present invention, a license management system for managing license information to execute a function of an electronic device includes an issuing unit configured to issue license information as to a function executed by the electronic device to the electronic device, an obtaining unit configured to obtain function execution information indicating the execution state of the function of the electronic device, and a compensating unit configured to execute, based on the function execution information, processing for compensating the license information of the function of which the execution state is indicated with the function execution information.

Other features and aspects of the present invention will be apparent from the following description taken in conjunction with the accompanying drawings, in which like reference characters designate the same or similar parts throughout the figures thereof.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating a first embodiment of the present invention, and illustrating a configuration example of a network system.

FIG. 2 is a diagram illustrating the first embodiment of the present invention, and illustrating a functional configuration example of a license information issuance server.

FIG. 3 is a diagram illustrating the first embodiment of the present invention, and illustrating a schematic configuration example of the license information issuance server.

FIG. 4 is a diagram illustrating the first embodiment of the present invention, and illustrating a screen example to be displayed on the display screens of display devices of a user terminal, seller terminal, and manufacturer terminal at the time a user, sales company, and software developer logging into the license information issuance server.

FIG. 5 is a diagram illustrating the first embodiment of the present invention, and illustrating an information example stored in a license information management database connected to the license information issuance server.

FIG. 6 is a diagram illustrating the first embodiment of the present invention, and illustrating a screen example for specifying an application provided by the license information issuance server.

FIG. 7 is a diagram illustrating the first embodiment of the present invention, and illustrating an example of a product type specification screen for specifying a product type.

FIG. 8 is a diagram illustrating the first embodiment of the present invention, and illustrating an example of a product registration screen.

FIG. 9 is a diagram illustrating the first embodiment of the present invention, and illustrating an example of a software identification code issuance product specification screen.

FIG. 10 is a diagram illustrating the first embodiment of the present invention, and illustrating an example of a software identification code issuance screen.

FIG. 11 is a diagram illustrating the first embodiment of the present invention, and illustrating an example of a software identification code input screen.

FIG. 12 is a diagram illustrating the first embodiment of the present invention, and illustrating an example of a license information issuance screen.

FIG. 13 is a diagram illustrating the first embodiment of the present invention, and illustrating an example of a license information obtaining screen.

FIG. 14 is a diagram illustrating the first embodiment of the present invention, and illustrating an example of a product registration screen in the case of a product type specifying no license condition at the time of product registration being selected.

FIG. 15 is a diagram illustrating the first embodiment of the present invention, and illustrating an example of a license information file issuance target product specification screen.

FIG. 16 is a diagram illustrating the first embodiment of the present invention, and illustrating an example of a license information file issuance screen.

FIG. 17 is a diagram illustrating the first embodiment of the present invention, and illustrating an example of information stored in the license information management database in more detail.

FIG. 18 is a diagram illustrating the first embodiment of the present invention, and is a flowchart for describing an example of processing at the network system at the time of registering a product to which a license is added in the license information issuance server.

FIG. 19 is a diagram illustrating the first embodiment of the present invention, and is a flowchart for describing an example of processing at the network system at the time of the license information issuance server registering a device product.

FIG. 20 is a diagram illustrating the first embodiment of the present invention, and illustrating an example of a device product registration screen for registering a device product.

FIG. 21 is a diagram illustrating the first embodiment of the present invention, and illustrating an example of a device product registration confirmation screen.

FIG. 22 is a diagram illustrating the first embodiment of the present invention, and illustrating an example of a new option function registration screen.

FIG. 23 is a diagram illustrating the first embodiment of the present invention, and illustrating an example of an option product registration screen.

FIG. 24 is a diagram illustrating the first embodiment of the present invention, and illustrating an example of an option product registration confirmation screen.

FIG. 25 is a diagram illustrating the first embodiment of the present invention, and is a flowchart for describing an example of processing at the network system at the time of the license information issuance server registering an option product.

FIG. 26 is a diagram illustrating the first embodiment of the present invention, and simply illustrating an example of information stored in the license information management database.

FIG. 27 is a diagram illustrating the first embodiment of the present invention, and is a flowchart for describing an example of software identification code issuance processing at the sales company or software developer.

FIG. 28 is a diagram illustrating the first embodiment of the present invention, and is a flowchart for describing an example of license information issuance processing by a user.

FIG. 29 is a diagram illustrating the first embodiment of the present invention, and is a flowchart for describing an example of license information issuance processing by the sales company or software developer.

FIG. 30 is a diagram illustrating the first embodiment of the present invention, and is a flowchart for describing an example of processing at the network system at the time of issuing a license access number.

FIG. 31 is a diagram illustrating the first embodiment of the present invention, and illustrating an example of a screen for setting an option product.

FIG. 32 is a diagram illustrating the first embodiment of the present invention, and illustrating an example of a license number issuance screen.

FIG. 33 is a diagram illustrating the first embodiment of the present invention, and illustrating an example of a license access number download screen.

FIG. 34 is a diagram illustrating the first embodiment of the present invention, and illustrating an example of an access number input screen.

FIG. 35 is a diagram illustrating the first embodiment of the present invention, and illustrating an example of a registration screen for requesting serial number input.

FIG. 36 is a diagram illustrating the first embodiment of the present invention, and illustrating an example of an information confirmation screen which is a screen for allowing a user to confirm license issuance.

FIG. 37 is a diagram illustrating the first embodiment of the present invention, and illustrating an example of a screen for displaying a license key number.

FIG. 38 is a diagram illustrating the first embodiment of the present invention, and is a flowchart for describing an example of processing at the network system at the time of issuing a license key.

FIG. 39 is a diagram illustrating the first embodiment of the present invention, and illustrating a hardware configuration example of a device.

FIG. 40 is a diagram illustrating the first embodiment of the present invention, and illustrating a functional configuration example of a portion relating to communication with the device managing server, of the functional configuration included in the device.

FIG. 41 is a diagram illustrating the first embodiment of the present invention, and illustrating a functional configuration example of a portion relating to communication with the device, of the functional configuration of the device managing server.

FIG. 42 is a diagram illustrating the first embodiment of the present invention, and illustrating an example of a setting registration screen prepared by the device managing server.

FIG. 43 is a diagram illustrating the first embodiment of the present invention, and is a flowchart for describing an example of processing at the network system at the time of understanding a problem and state occurring at the device.

FIG. 44 is a diagram illustrating the first embodiment of the present invention, and illustrating an example of an error monitoring target table.

FIGS. 45A and 45B are diagrams illustrating the first embodiment of the present invention, and conceptually illustrating an example of device monitoring processing in the case of an error of a first error type occurring at the device.

FIG. 46 is a diagram illustrating the first embodiment of the present invention, and illustrating an example of a power off request screen.

FIGS. 47A and 47B are diagrams illustrating the first embodiment of the present invention, and illustrating an example of device-unavailable information.

FIG. 48 is a diagram illustrating the first embodiment of the present invention, and is a flowchart for describing an example of processing at the network system at the time of determining license compensation.

FIG. 49 is a diagram illustrating the first embodiment of the present invention, and illustrating an example of a screen to be displayed on the seller terminal at the time of an operator of the sales company manually determining whether or not a license is to be compensated.

FIG. 50 is a diagram illustrating the first embodiment of the present invention, and illustrating an example of a screen to be displayed on the seller terminal at the time of automatically determining whether or not a license is to be compensated.

FIG. 51 is a diagram illustrating the first embodiment of the present invention, and illustrating an example of the content of an e-mail for informing a user that a license has been compensated.

FIG. 52 is a diagram illustrating a second embodiment of the present invention, and is a flowchart for describing an example of processing at the license information issuance server at the time of classifying license compensation in increments of software function.

### DESCRIPTION OF THE EMBODIMENTS

Next, embodiments of the present invention will be described in detail with reference to the accompanying drawings. Note that the following respective embodiments are but exemplifications, and do not imply that the scope of the present invention is restricted thereto.

### First Embodiment

### Description of Network System

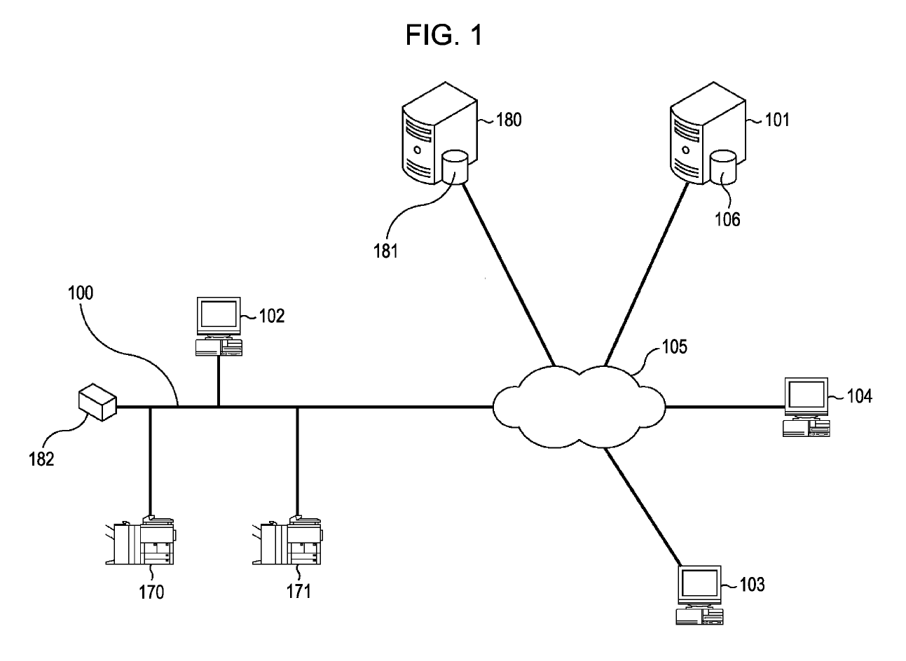

FIG. 1 is a diagram illustrating a configuration example of a network system which is an example of a license management system. The network system shown in FIG. 1 is a system for managing software necessary for processing by a device, or managing a device. The term “management of software” means, for example, to issue license information in exchange of input of an individual number for uniquely identifying a device for introducing software for preventing illegal use of software, and manage the license information thereof. Also, the term “management of devices” means, for example, to manage the use situation or state of a device to be managed by the above-mentioned software.

In FIG. 1, a license information issuance server 101 is an information processing device for controlling the entirety of license information issuance processing. A device managing server 180 is an information processing device for controlling management of the use situations or states of devices 170 and 171 connected to a network 105. The device managing server 180 can directly obtain management of the use situations or states of the devices 170 and 171 from the devices 170 and 171 through the network 105 such as the Internet or the like. Also, the device managing server 180 can also obtain management of the use situations or states of the devices 170 and 171 through a monitoring device 182.

A user terminal 102 is an information processing device managed by a user. All kinds of information processing device capable of connecting to the network 105, and also capable of installing software can become the user terminal 102, such as a personal computer, portable terminal, printer, copying machine, or the like. The devices 170 and 171 each including a printing apparatus are connected to the user terminal 102 through a network 100, such as a LAN or the like. The user terminal 102 can use a licensed option function which is a function that can be executed by the devices 170 and 171. Note that, as described above, the devices 170 and 171 may be printers, copying machines, or the like, so an arrangement may be made wherein the devices 170 and 171 are the user terminals 102.

The devices 170 and 171, which are examples of electronic devices, are connected to the network 100, and have an arrangement to inform the device managing server 180 of device operation information including the number of printed sheets, failure information, and so forth. Even in a case wherein an arrangement to inform the device managing server 180 of the device operation information is not implemented in the devices 170 and 171, the monitoring device 182 connected to the network 100 can collect the device operation information of the devices 170 and 171. In such a case, the monitoring device 182 informs the device managing server 180 of the collected device operation information.

The monitoring device 182 has not only a function for informing the device managing server 180 of the device operation information but also a function for monitoring the multiple devices 170 and 171. The devices 170 and 171 monitored by the monitoring device 182 can be set by the user terminal 102. The devices 170 and 171 which operate by obtaining a license are included in the monitoring targets of the device managing server 180, or excluded from the monitoring targets of the device managing server 180.

Also, the seller terminal 103 is, for example, an information processing device managed by a sales company. The manufacturer terminal 104 is, for example, an information processing device managed by a software developer. A personal computer or workstation can become the seller terminal 103 or manufacturer terminal 104. The network 105 is a network such as the Internet, a phone line, or the like. The user terminal 102, seller terminal 103, and manufacturer terminal 104 are mutually connected to the license information issuance server 101 or device managing server 180 through the network 105. The license information management database 106 is connected to the license information issuance server 101. The data stored in the license information management database 106 is application information, product information including license information, actor information, software identification code information, device serial number information, device product information, and machine number data band information. In addition to these, application IDs, device product code correlation information, option product information, license access number information, license key information, option information, customer information, and compensation processing information, and so forth are stored in the license information management database 106.

A device management database 181 is connected to the device managing server 180. Device information, printing information such as the number of printed sheets, paper size, duplex printing, and so forth, scanning information such as the number of scanned sheets and so forth, component information, ROM version information, and so forth are stored in the device management database 181. Also, the device management database 181 also stores analytical information and so forth obtained with collection information such as failure information, warning information, and so forth occurring at the devices 170 and 171, and obtained by the collection information being subjected to processing.

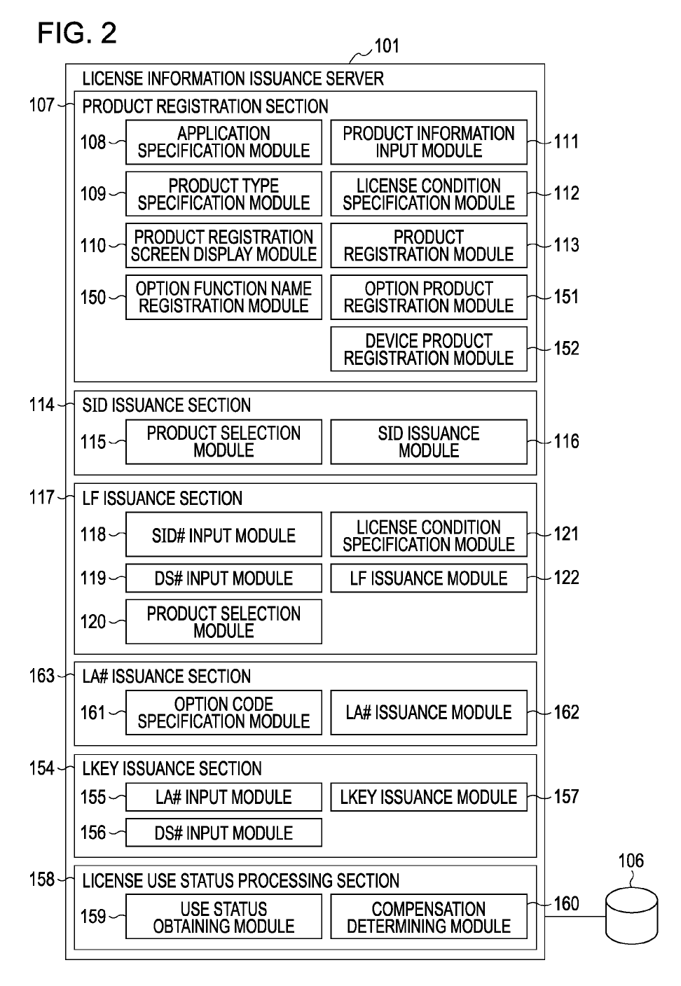

FIG. 2 is a diagram illustrating a functional configuration example of the license information issuance server 101. A product registration section 107 includes an application specification module 108, product type specification module 109, product registration screen display module 110, product information input module 111, and license condition specification module 112. Further, the product registration section 107 includes a product registration module 113, option function name registration module 150, option product registration module 151, and device product registration module 152.

An SID issuance section 114 includes a product selection module 115, and SID issuance module 116. An LF (License File) issuance section 117 includes an SID# input module 118, DS# input module 119, product selection module 120, license condition specification module 121, and LF issuance module 122.

An LA# issuance section 163 includes an option code specification module 161 for specifying an option for issuing a license access number (LA#), and an LA# issuance module 162 for issuing a license access number (LA#). An LKEY issuance section 154 includes an LA# input module 155, DS# input module 156, and LKEY issuance module 157. A license use status processing section 158 includes a use status obtaining module 159 for obtaining the use status of an issued license, and a compensation determining module 160 which performs determination for reviewing already-existing licenses, based on data collected by the use status obtaining module 159.

In order to enable the software managed by the network system shown in FIG. 1 to be used at the user terminal 102 managed by the user, the license information issued from the license information issuance server 101 is always needed. In response to appropriate access through the network 105, the license information issuance server 101 issues license information to an information processing device which has accessed thereto. The identification information unique to an information processing device which is a software install destination is embedded in the license information. At the time of installing the same software into multiple information processing devices, each information processing device needs different license information. Thus, this can prevent the software from being copied without notice. The license information issued by the license information issuance server 101 includes a later-described license file (LF) and license key (LKEY).

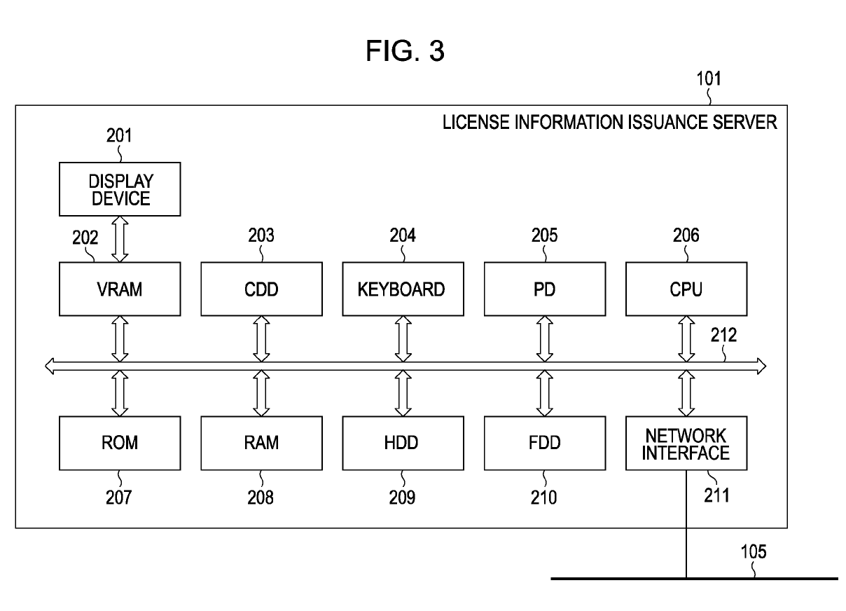

FIG. 3 is a diagram illustrating a schematic configuration example of the license information issuance server 101. In FIG. 3, a display device 201 is a computer display such as an LCD (Liquid Crystal Display) or the like. On the display screen of the display device 201, for example, user interface information such as a window, icon, message, menu, and so forth are displayed. VRAM 202 stores image data to be displayed on the display device 201. The image data stored in the VRAM 202 is transferred to the display device 201 in accordance with a predetermined rule. Thus, an image is displayed on the display device 201.

A CDD (Compact Disc Drive) 203 is a device for reading/writing various control programs and data with a recoding medium such as CD-ROM, CD-R, or the like. Note that in addition to the CDD 203 or instead of the CDD 203, a DVD drive may be employed. A keyboard 204 has various keys for allowing the user to perform various types of input such as characters and so forth. A PD (Pointing Device) 205 is employed, for example, for specifying an icon, menu, and other objects displayed on the display screen of the display device 201.

A CPU 206 controls each device mutually connected through a CPU bus 212 based on a control program stored in ROM 207, HDD (Hard Disk Drive) 209, FDD (Flexible Disk Drive) 210, and CDD 203. The ROM (Read Only Memory) 207 holds various control programs and data. The RAM (Random Access Memory) 208 has the work area of the CPU 206, data save area at the time of error processing, and load area of a control program or the like.

The HDD 209 saves various control programs and various data. A network interface (Net I/F) 211 performs communication with the license information issuance server 101, user terminal 102, seller terminal 103, manufacturer terminal 104, monitoring device 182, and devices 170 and 171 or the like through a network 213. The CPU bus 212 includes an address bus, data bus, and control bus. Provision of a control program as to the CPU 206 can be performed from any of the ROM 207, HDD 209, FDD 210, and CDD 203, and also can be performed from an external information processing device or the like through the network 105.

Though description has been made so far regarding the hardware configuration of the license information issuance server 101 with reference to FIG. 3, the device managing server 180, user terminal 102, seller terminal 103, manufacturer terminal 104, and monitoring device 182 can also have the same configurations as those shown in FIG. 3. Accordingly, detailed description regarding the configurations of the device managing server 180, user terminal 102, seller terminal 103, manufacturer terminal 104, and monitoring device 182 will be omitted.

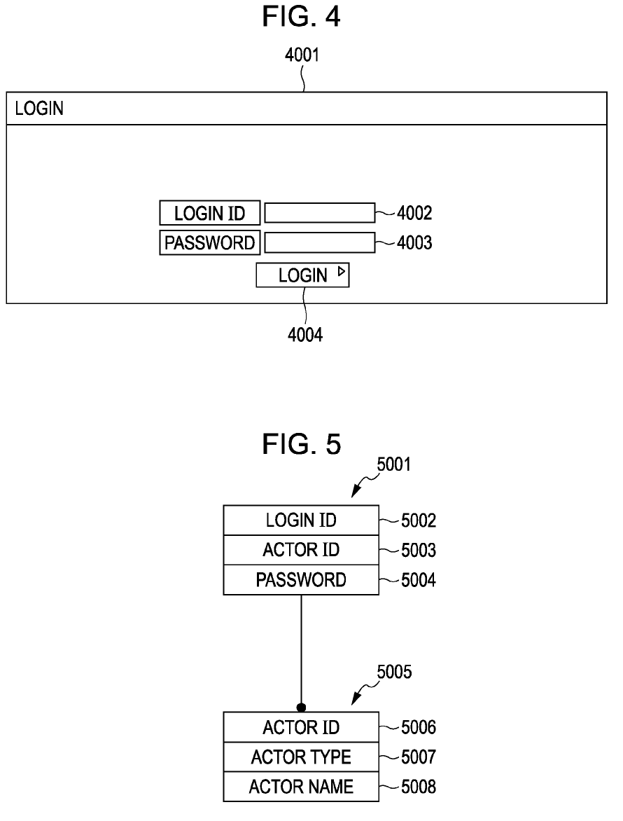

Next, an example of the operation of the license information issuance server 101 will be described. FIG. 4 is a diagram illustrating an example of a screen to be displayed on the display screens of the display devices 201 of the user terminal 102, seller terminal 103, and manufacturer terminal 104 at the time of the user, sales company, and software developer logging into the license information issuance server 101. On the login screen 4001 shown in FIG. 4 a login ID input field 4002, password input field 4003, and “Login” button 4004 are displayed. Before each operator, i.e., the user, sales company, and software developer, performing work such as issuance of license information, or the like, at the license information issuance server 101, the operator first employs the login screen 4001 shown in FIG. 4 to log into the network system shown in FIG. 1.

FIG. 5 is a diagram illustrating an example of information stored in the license information management database 106 connected to the license information issuance server 101. The license information management database 106 stores an account table 5001 including account information, and an actor table 5005 including actor information. The account table 5001 stores a login ID 5002 for uniquely identifying an operator to attempt login, an actor ID 5003 for uniquely identifying a sales entity, and a password 5004 at the time of login in a mutually correlated manner. The actor table 5005 stores an actor ID 5006 for uniquely identifying a sales entity, an actor type 5007 indicating the type of the sales company or software developer, and an actor name 5008 in a mutually correlated manner.

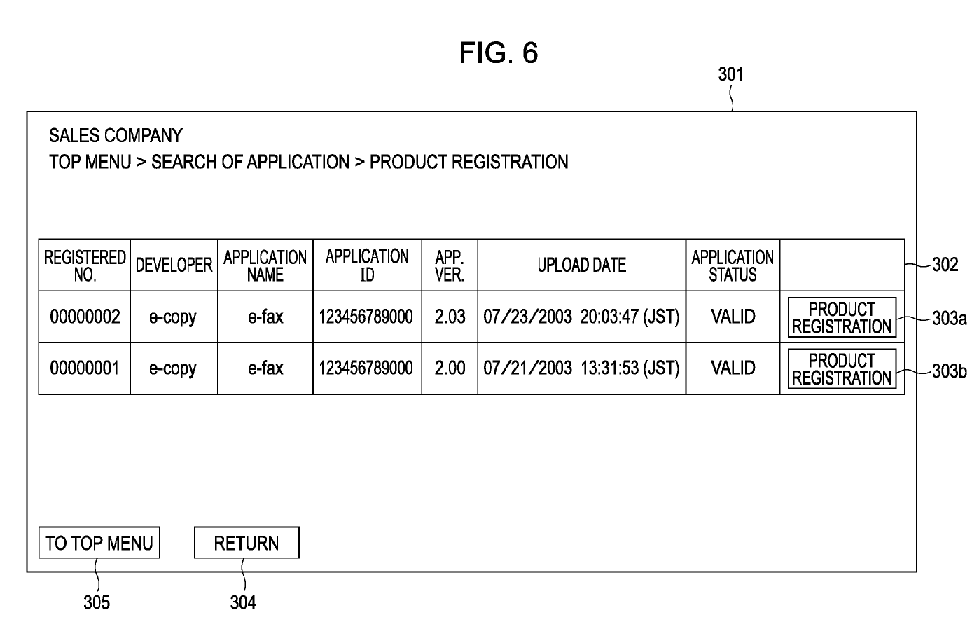

FIG. 6 illustrates an example of a screen for specifying an application provided by the license information issuance server 101. When receiving access from the seller terminal 103 through the network 105, the license information issuance server 101 transmits image data for displaying a product registration application specification screen 301 shown in FIG. 6 to the seller terminal 103.

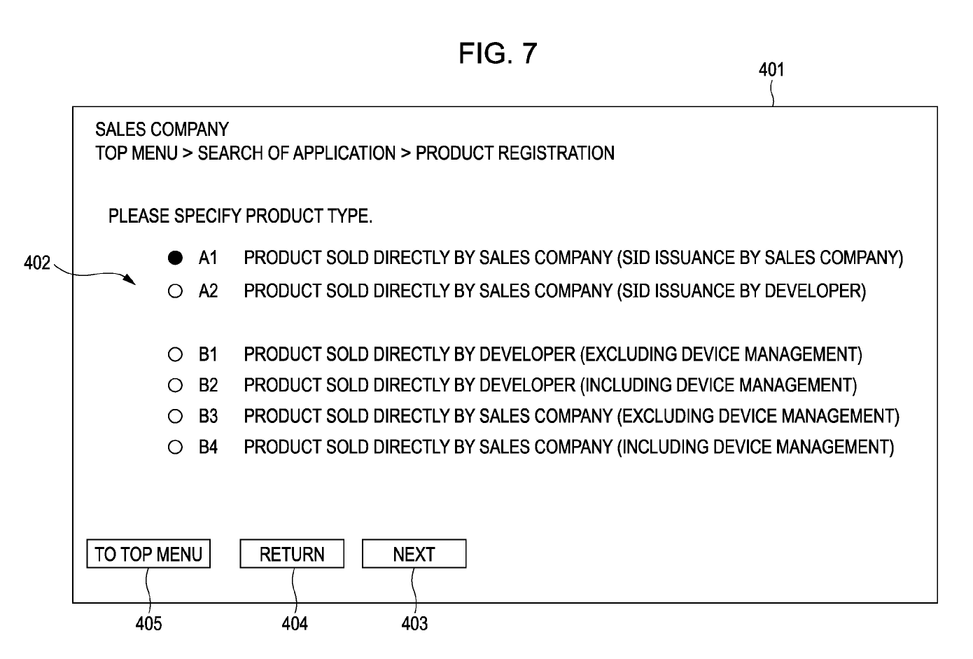

In FIG. 6, on the product registration application specification screen 301 an application list 302, “Product Registration” buttons 303a and 303b, and “Return” button 304, and “to Top Menu” button 305 are displayed. When performing product registration, the operator of the sales company first specifies an application of which the product registration is to be performed from the application list registered in the network system at the product registration application specification screen 301 shown in FIG. 6. Upon the “Product Registration” button 303 being selected, a product type specification screen 401 shown in FIG. 7 is displayed. Upon the “Return” button 304 being selected, the previous screen is displayed. Upon the “to Top Menu” button 305 being selected, a Top Menu screen is displayed.

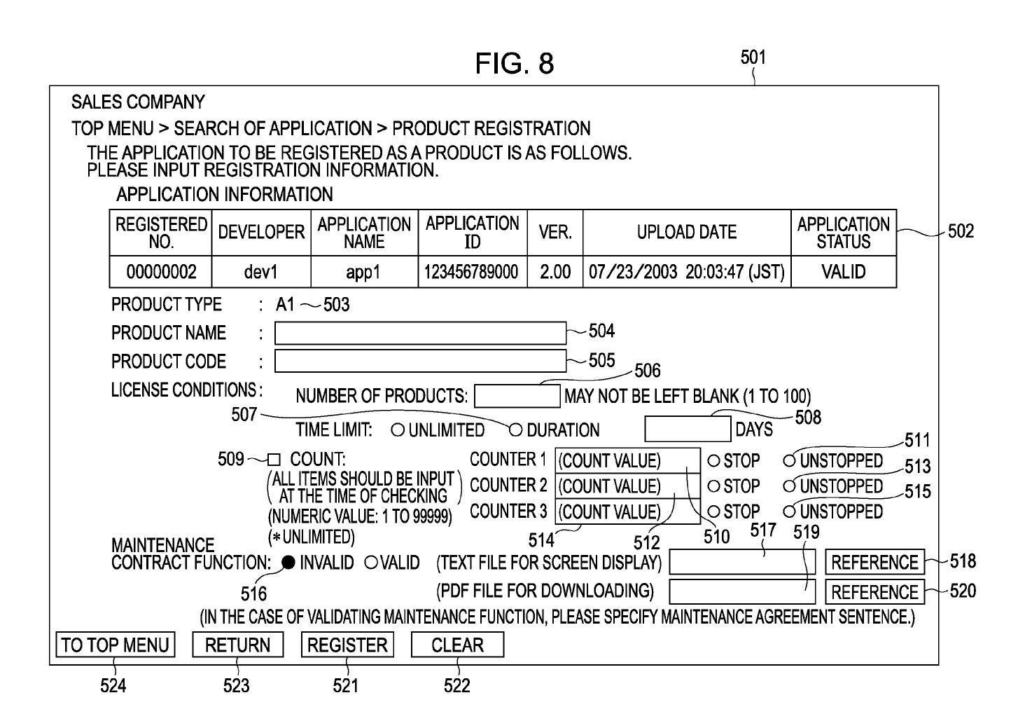

FIG. 7 is a diagram illustrating an example of a product type specification screen for specifying a product type. When receiving access from the seller terminal 103 through the network 105, the license information issuance server 101 transmits image data for displaying the product type specification screen shown in FIG. 7 to the seller terminal 103. On the product type specification screen 401 shown in FIG. 7 selectable product type selection radio buttons 402 are displayed. With the product type specification screen 401 shown in FIG. 7, upon a “Next” button 403 being selected after the type of a product to be registered is selected, a product registration screen 501 shown in FIG. 8 is displayed. Upon a “Return” button 404 being selected, the previous screen is displayed. Upon a “to Top Menu” button 405 being selected, the Top Menu screen is displayed.

Note that in FIG. 7, a product type A1 is a product which the sales company serving as a sales entity sells. Whether or not there are license conditions and maintenance contract function is registered in the product type A1. The products of the product type A1 are sold in a state wherein the software identification code which the sales company (seller terminal 103) obtained from the license information issuance server 101 is included in a software package. The user who purchased the product of the product type A1 inputs the software identification code thereof, and the device serial number of the computer (user terminal 102) to install the product to the user terminal 102. Subsequently, the user terminal 102 obtains license file information from the license information issuance server 101, and installs the product of the product type A1 based on the obtained license file information.

Also, a product type A2 is a product which the sales company serving as a sales entity sells. Whether or not there are license conditions and maintenance contract function is registered in the product type A2. The products of the product type A2 are sold by the sales company in a state wherein the software identification code which the software developer (manufacturer terminal 104) obtained from the license information issuance server 101 is included in a software package. The user who purchased the product of the product type A2 inputs the software identification code thereof, and the device serial number of the information processing device (user terminal 102) to install the product to the user terminal 102. Subsequently, the user terminal 102 obtains license file information from the license information issuance server 101, and installs the product of the product type A2 based on the obtained license file information.

A product type B1 is a product which the software developer serving as a sales entity sells. No license condition is registered for the products of the product type B1. The products of the product type B1 are sold in a state wherein the license information which the software developer (manufacturer terminal 104) obtained from the license information issuance server 101 by specifying license conditions is included in a software package. A product type B2 is a product which the software developer serving as a sales entity sells. No license condition is registered for the products of the product type B2. The products of the product type B2 are sold in a state wherein the license information which the software developer (manufacturer terminal 104) obtained from the license information issuance server 101 by specifying license conditions and the device serial number of the device to install the product is included in a software package.

A product type B3 is a product which the sales company serving as a sales entity sells. No license condition is registered in the product type B3. The products of the product type B3 are sold in a state wherein the license information which the sales company (seller terminal 103) obtained from the license information issuance server 101 by specifying license conditions is included in a software package. A product type B4 is a product which the sales company serving as a sales entity sells. No license condition is registered in the product type B4. The products of the product type B4 are sold in a state wherein the license information which the sales company (seller terminal 103) obtained from the license information issuance server 101 by specifying license conditions and the device serial number of the device to install the product is included in a software package.

FIG. 8 is a diagram illustrating an example of a product registration screen provided by the license information issuance server 101. When receiving access from the seller terminal 103 through the network 105, the license information issuance server 101 transmits image data for displaying a product registration screen 501 shown in FIG. 8 to the seller terminal 103. Specifically, when the license information issuance server 101 detects that the “Next” button 403 has been selected following the product type A1 or A2 shown in FIG. 7 being selected, the license information issuance server 101 transmits image data for displaying the product registration screen 501 to the seller terminal 103.

Now, the details of the product registration screen 501 shown in FIG. 8 will be described. Information 502 of an application serving as a product registration target, selected product type 503, product name input box 504, product code input box 505, and number of licenses input box 506 are displayed on the product registration screen 501. Further, on the product registration screen 501a license limit type specification radio button 507 is displayed, and in the case of the license limit being a certain period of time, a license limit input box 508 and count condition specification check box 509 are also displayed. Further, on the product registration screen 501a count value input box 510 of “counter 1”, and stop/unstopped specification button 511 of “counter 1” are displayed. Further, on the product registration screen 501a count value input box 512 of “counter 2”, and stop/unstopped specification button 513 of “counter 2” are displayed. Further, on the product registration screen 501a count value input box 514 of “counter 3”, and stop/unstopped specification button 515 of “counter 3” are displayed. Further, on the product registration screen 501a maintenance contract function valid/invalid specification radio button 516, a file name input box 517 for maintenance contractual term screen display, and a file name specification button 518 for maintenance contractual term screen display are displayed. Further, on the product registration screen 501a file name input box 519 for maintenance contractual term download, and a file name specification button 520 for maintenance contractual term download are displayed. Additionally, on the product registration screen 501a “Register” button 521, “Clear” button 522, “Return” button 523, and “to Top Menu” button 524 are displayed.

The operator of the sales company confirms the content of the application serving as a product registration target at the product registration screen 501 shown in FIG. 8. Next, the operator of the sales company can perform product registration by selecting the “Register” button 521 after inputting a product name, product code, number of licenses, license limit, license count information, and maintenance contract information. Upon the operator of the sales company selecting the “Clear” button 522, the content having been input after the product registration screen 501 was displayed is all cleared. Upon the operator of the sales company selecting the “Return” button 523, the previous screen is displayed, and upon the operator of the sales company selecting the “to Top Menu” button 524, the Top Menu screen is displayed.

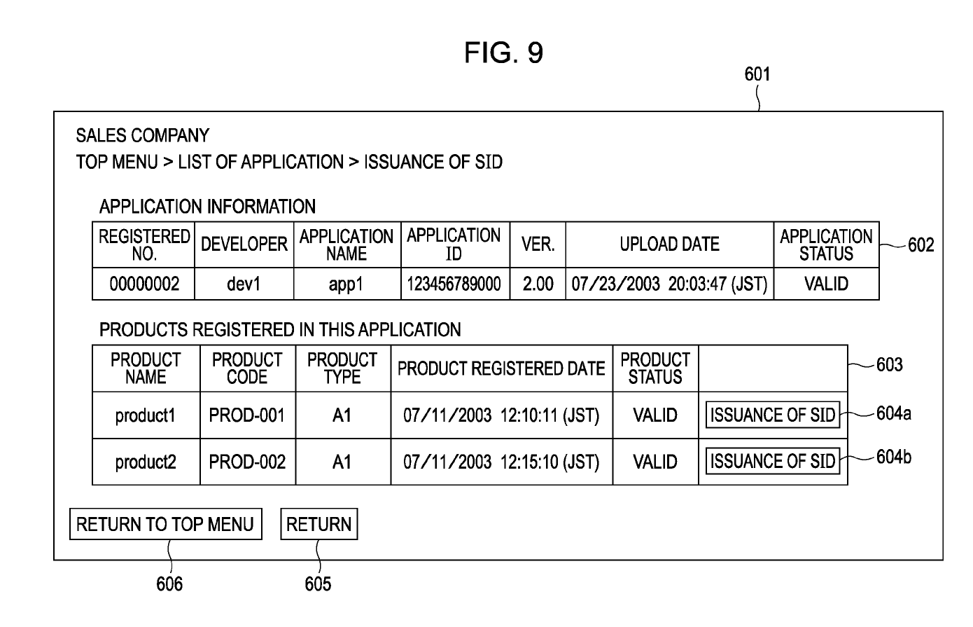

FIG. 9 is a diagram illustrating an example of a software identification code issuance product specification screen provided by the license information issuance server 101. In response to access from the seller terminal 103 or manufacturer terminal 104 through the network 105, the license information issuance server 101 transmits image data for displaying the software identification code issuance product specification screen 601 shown in FIG. 9 to the terminal which has accessed.

On the software identification code issuance product specification screen 601 application information 602, product list 603 registered in the application, “Issuance of SID” buttons 604a and 604b, “Return” button 605, “Return to Top Menu” button 606 are displayed. When issuing a software identification code, the operator of the sales company or software developer employs the software identification code issuance product specification screen 601. With the software identification code issuance product specification screen 601, the operator of the sales company or software developer specifies a product of which the software identification code is issued from the product list 603 registered in the application to be processed.

Note that upon the operator of the sales company or software developer selecting “Return” button 605, the previous screen is displayed. Upon the operator of the sales company or software developer selecting “Return to Top Menu” button 606, the Top Menu screen is displayed.

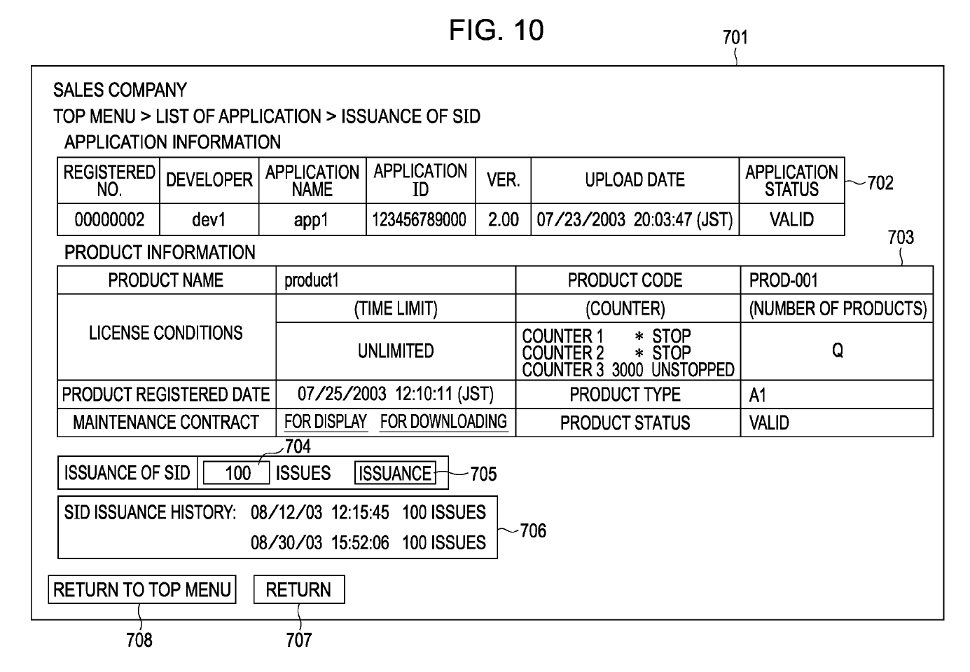

FIG. 10 is a diagram illustrating an example of a software identification code issuance screen provided by the license information issuance server 101. When the “Issuance of SID” button 604 shown in FIG. 9 is selected, the license information issuance server 101 transmits image data for displaying a software identification code issuance screen 701 to the terminal wherein the “Issuance of SID” button 604 thereof has been selected.

Now, the details of the software identification code issuance screen 701 shown in FIG. 10 will be described. On the software identification code issuance screen 701, application information 702, and product information 703 serving as the software identification code issuance target specified at the software identification code issuance product specification screen 601 are displayed. Further, on the software identification code issuance screen 701 an input box 704 for inputting the number of licenses to issue a software identification code, “Issuance” button 705, and software identification code issuance history display 706 are displayed. Additionally, on the software identification code issuance screen 701a “Return” button 707 and “Return to Top Menu” button 708 are displayed.

The operator of the sales company or software developer can instruct issuance of a software identification code by selecting the “Issuance” button 705 after inputting the number of licenses to issue a software identification code to the input box 407. Note that upon the operator of the sales company or software developer selecting the “Return” button 707, the previous screen is displayed. Upon the operator of the sales company or software developer selecting the “Return to Top Menu” button 708, the Top Menu screen is displayed.

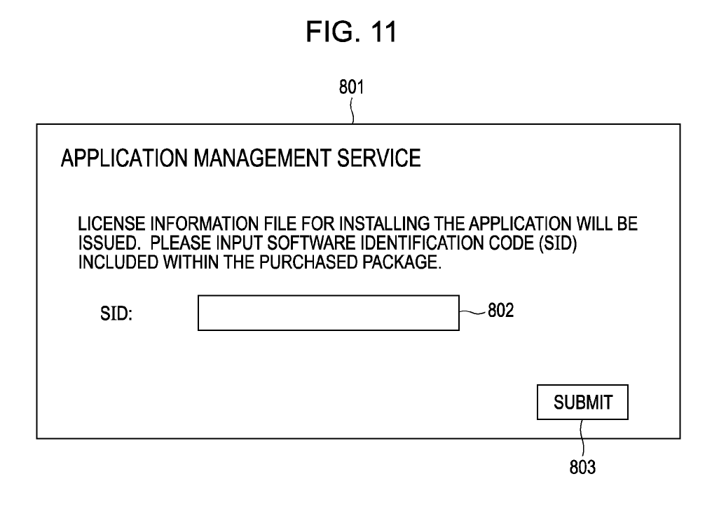

FIG. 11 is a diagram illustrating an example of a software identification code input screen provided by the license information issuance server 101. When receiving access form the user terminal 102 through the network 105, the license information issuance server 101 transmits image data for displaying the software identification code input screen 801 shown in FIG. 11 to the user terminal 102. On the software identification code input screen 801, a software identification code input box 802 and submit button 803 are displayed.

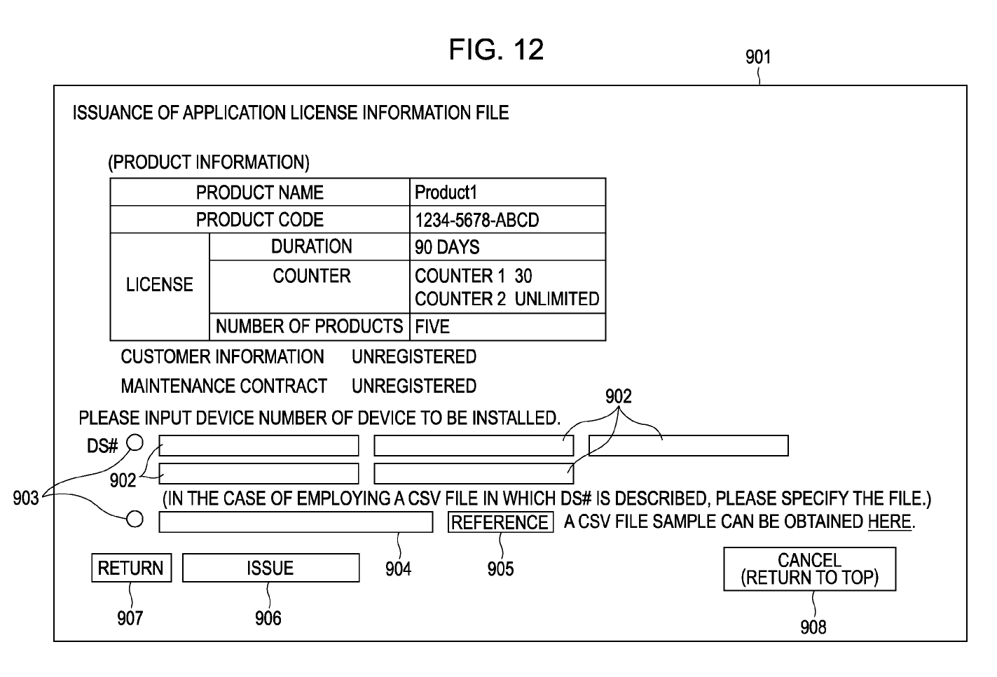

When issuing license information, the user employs the software identification code input screen 801. When the software identification code input screen 801 is displayed, the user inputs the software identification code described in the purchased software package to the software identification code input box 802, and selects the submit button 803. Upon the submit button 803 being selected, a license information issuance screen 901 shown in FIG. 12 is displayed.

FIG. 12 is a diagram illustrating an example of the license information issuance screen provided by the license information issuance server 101. When receiving information indicating that the submit button 803 shown in FIG. 11 has been selected from the user terminal 102, the license information issuance server 101 transmits image data for displaying the license information issuance screen 901 shown in FIG. 12 to the user terminal 102. On the license information issuance screen 901 product information (software information), device serial number input boxes 902, device serial number input method selection radio button 903, and device serial number file name input box 904 are displayed. Further, on the license information issuance screen 901a device serial number file specification reference button 905, and an “Issue” button 906 for instructing issuance of license information are displayed. Additionally, on the license information issuance screen 901 a “Return” button 907 for returning to the previous screen, and a “Cancel” button 908 for canceling license information issuance processing itself are displayed.

The number of the device serial number input boxes 902 is identical to a smaller number of the value obtained by subtracting the number of issued licenses from the number of software licenses, and the maximum number of displays of the device serial number file name input box 904. With the license information issuance screen 901, after confirming that the displayed software is matched with the purchased software, the user selects a method for specifying the serial numbers of the devices 170 and 171 at the device serial number input method selection radio button 903. In the case of the user selecting the radio button on the upper side, the user inputs the serial numbers of the devices 170 and 171 at the user terminal 102 to install the software to the device serial number input boxes 902.

On the other hand, in the case of the user selecting the radio button on the lower side, the user inputs a device serial number file with absolute paths to the device serial number file name input box 904, or selects the device serial number file specification reference button 905. Next, when a file specification dialog box provided in the operating system as a standard tool is displayed, the user specifies a device serial number file as to the file specification dialog box thereof.

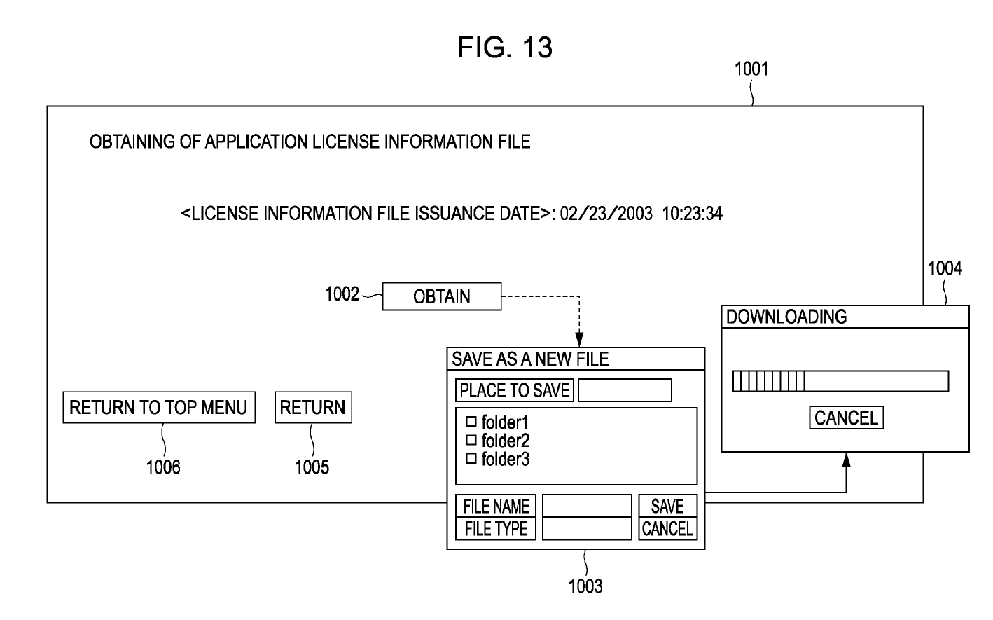

After performing specification of a device serial number as described above, the user selects the “Issue” button 906. Thus, license information necessary for installing software into the input device serial number is generated at a predetermined location within the license information issuance server 101. Upon generation of the license information being completed, the license information issuance server 101 transmits image data for displaying a license information obtaining screen 1001 shown in FIG. 13 to the user terminal 102.

FIG. 13 is a diagram illustrating an example of a license information obtaining screen provided by the license information issuance server 101. In FIG. 13, on the license information obtaining screen 1001 license information issuance date and time (<license file issuance date>) is displayed. Further, on the license information obtaining screen 1001 an “Obtain” button 1002 for instructing obtaining of license information, and a “Return” button 1005 for returning to the previous screen, and a “Return to Top Menu” button 1006 for returning to the Top Menu are displayed.

With the license information obtaining screen 1001, upon the user selecting the “Obtain” button 1002 to obtain license information (file) previously issued, a file specification dialog box 1003 provided in the operating system as a standard tool is displayed. With this file specification dialog box 1003, the user instructs save after inputting an optional save destination of the license information (file), and the file name thereof. Thus, a downloading dialog box 1004 provided in the operating system as a standard tool is displayed, and downloading of the license information is performed.

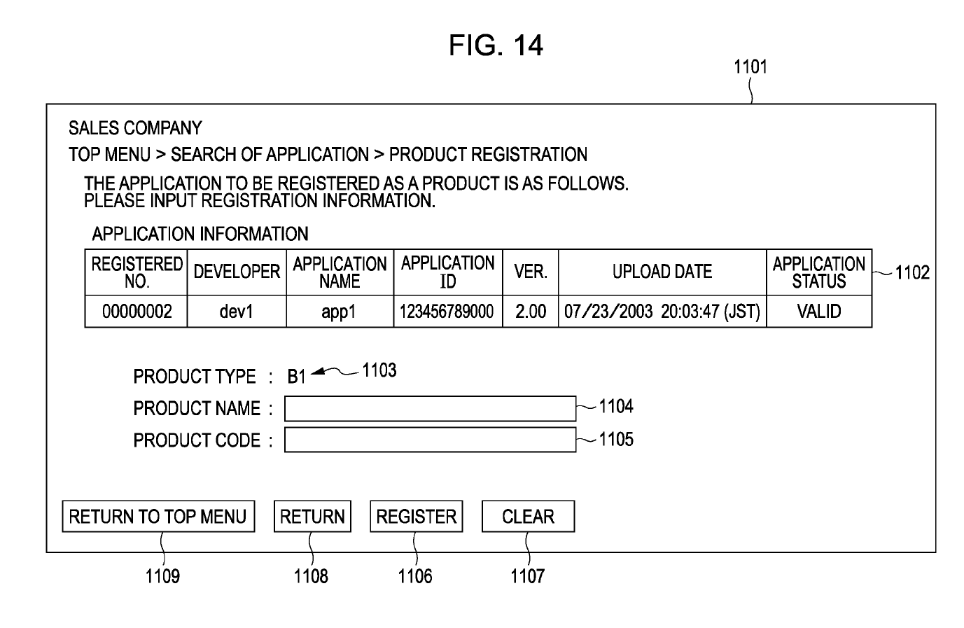

FIG. 14 is a diagram illustrating an example of a product registration screen provided by the license information issuance server 101 in the case of selecting a product type specifying no license condition at the time of product registration. When receiving access from the seller terminal 103 through the network 105, the license information issuance server 101 transmits image data for displaying a product registration screen 1101 shown in FIG. 14 to the seller terminal 103. Specifically, when the license information issuance sever 101 detects that the “Next” button 403 has been selected following any of the product types B1 through B4 shown in FIG. 7 having been selected, the license information issuance server 101 transmits image data for displaying the product registration screen 1101 to the seller terminal 103.

On the product registration screen 1101 information (application information) 1102 of an application serving as a product registration target, selected product type 1103, product name input box 1104, and product code input box 1105 are displayed. Further, on the product registration screen 1101 a “Register” button 1106, “Clear” button 1107, “Return” button 1108, and “Return to Top Menu” button 1109 are displayed.

With the product registration screen 1101, following confirming the content of the application serving as a product registration target, the operator of the sales company inputs a product name, and product code. Subsequently, upon the operator of the sales company selecting the “Register” button 1106, product registration can be performed. Upon the operator of the sales company selecting the “Clear” button 1107, the content having been input after the product registration screen 1101 was displayed is all cleared. Also, upon the operator of the sales company selecting the “Return” button 1108, the previous screen is displayed. Further, upon the operator of the sales company selecting the “Return to Top Menu” button 1109, the Top Menu screen is displayed.

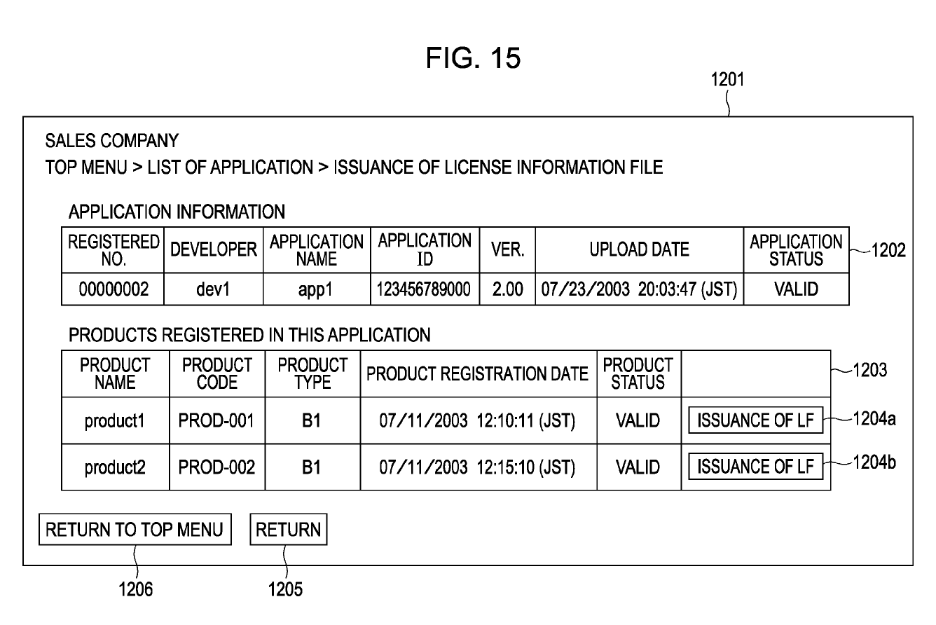

FIG. 15 is a diagram illustrating an example of a license information file issuance target product specification screen provided by the license information issuance server 101 when issuing a license information file as to the sales company or software developer. On the license information file issuance target product specification screen 1201 shown in FIG. 15 application information 1202, a product list 1203 registered in the application, and “Issuance of LF” buttons 1204a and 1204b are displayed. Further, on the license information file issuance target product specification screen 1201 a “Return” button 1205, and “Return to Top Menu” button 1206 are displayed.

When issuing a license information file, the operator of the sales company or software developer employs the license information file issuance target product specification screen 1201. When the license information file issuance target product specification screen 1201 is displayed, the user specifies a product of which the license information file is to be issued from the product list 1203 registered in the application to be processed. Note that upon the operator of the sales company or software developer selecting the “Return” button 1205, the previous screen is displayed. Also, upon the operator of the sales company or software developer selecting the “Return to Top Menu” button 1206, the Top Menu screen is displayed.

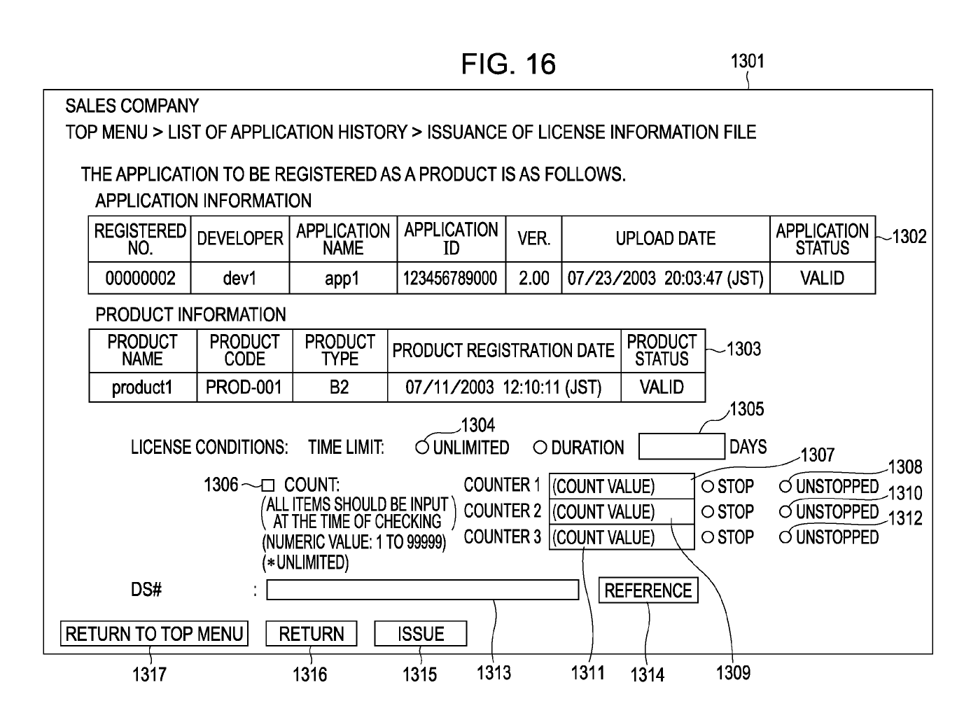

FIG. 16 is a diagram illustrating an example of a license information file issuance screen provided by the license information issuance server 101 in the case of the sales company or software developer issuing a license information file. On the license information file issuance screen 1301 information (application information) 1302 of an application serving as a license information file issuance target, selected product information 1303, and license condition setting portions 1304 through 1317 are displayed.

The license condition setting portions include a license limit type specification radio button 1304, license limit input box 1305 in the case of the license limit being a certain period of time, and count condition specification check box 1306. Further, the license condition setting portions include a count value input box 1307 of “counter 1”, and stop/unstopped specification button 1308 of “counter 1”. Further, the license condition setting portions include a count value input box 1309 of “counter 2”, and stop/unstopped specification button 1310 of “counter 2”. Further, the license condition setting portions include a count value input box 1311 of “counter 3”, and stop/unstopped specification button 1312 of “counter 3”. Additionally, on the license condition setting portions a device serial number input box 1313, device serial number file specification button 1314, “Issue” button 1315, “Return” button 1316, and “Return to Top Menu” button 1317 are displayed.

Following confirming the content of the application serving as a license information file issuance target, the operator of the sales company or software developer inputs a license limit, license count information, and the device serial number of a device on which the software is to be installed. Subsequently, upon the operator of the sales company and software developer selecting the “Issue” button 1315, issuance of a license information file is performed. Also, upon the operator of the sales company or software developer selecting the “Return” button 1316, the previous screen is displayed. Further, upon the operator of the sales company or software developer selecting the “Return to Top Menu” button 1317, the Top Menu screen is displayed. Upon issuance of the license information file being completed, the license information obtaining screen 1001 shown in FIG. 13 is displayed. As described above, the license information file can be obtained by employing the license information obtaining screen 1001.

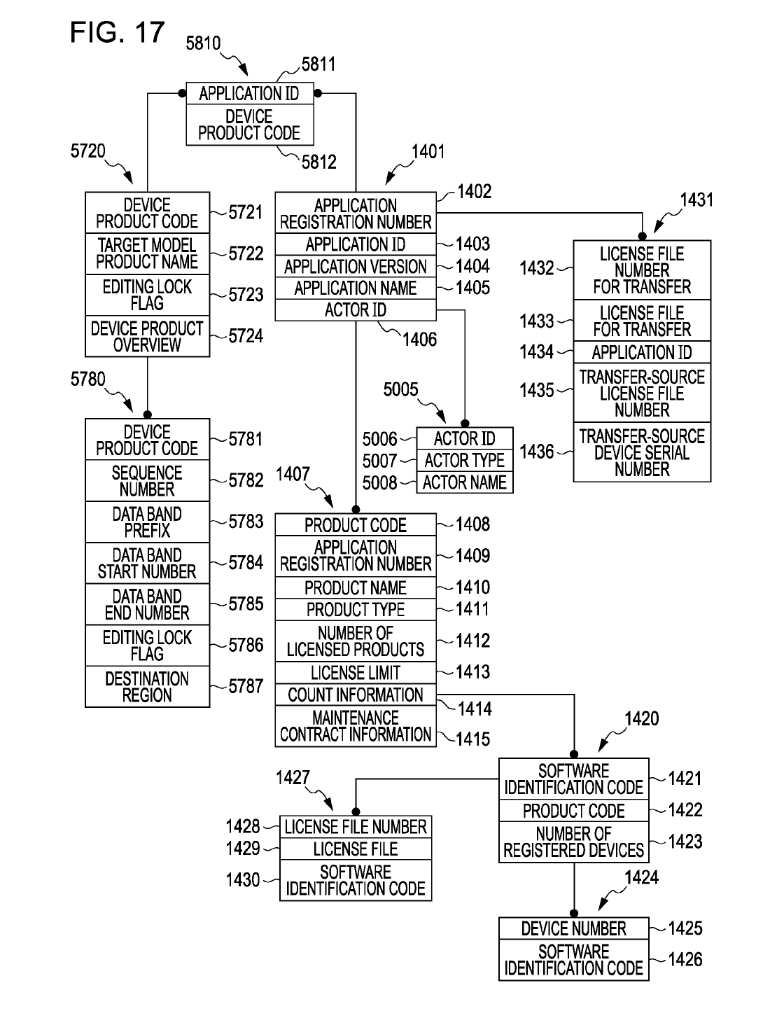

FIG. 17 is a diagram illustrating an example of information stored in the license information management database 106 connected to the license information issuance server 101 in more detail. In FIG. 17, the license information management database 106 stores application information (application table 1401), product information (product table 1407) including license information, and actor information (actor table 5005). Further, the license information management database 106 stores software identification code information (software identification code table 1420), and device serial number information (device table 1424).

Now, the term “software” has the same meaning as general software which is installed in an information processing device, and is operated to produce value. The term “application” means software developed by the software developer to enable particular processing to be performed on an information processing device. Also, the term “product” means the sales unit of applications registered in the network system, and is sales unit wherein a sales entity, circulation route, license conditions, and so forth are stipulated. Following purchasing a product, the user installs the application thereof in the user's own information processing device (user terminal 102) to employ the application.

The application table 1401 stores an application registration number 1402 for uniquely identifying an application on the network system, and an application ID 1403. Further, the application table 1401 stores an application version 1404, application name 1405, and actor ID 1406.

The product table 1407 stores a product code 1408, application registration number 1409, product name 1410, product type 1411, number of licenses 1412, license limit 1413, count information 1414, and maintenance contract information 1415. When product registration employing the screens 301, 401, and 501 shown in FIGS. 6 through 8 is performed, the information input to the screens 301, 401, and 501 is stored in each field within the product table 1407. An application has a relation of one on multiple as to products. Accordingly, multiple products may exist as to the same application.

The actor table 5005 stores, as described above, an actor ID 5006 for uniquely identifying a sales entity, actor type 5007 indicating the type of the sales company or software developer, and actor name ID 5008. The software identification code table 1420 stores a software identification code 1421, product code 1422, and number of registered devices 1423. A product has a relation of one on multiple as to software identification codes. Accordingly, multiple software identification codes may exist as to the same product.

The device table 1424 stores a device serial number 1425, and software identification code 1426. A software identification code has a relation of one on multiple as to devices. Accordingly, multiple devices may exist as to the same software identification code. The license file table 1427 stores a license file number 1428, license file 1429, and software identification code 1430. A software identification number has a relation of one on one as to a license file. Also, a license file has a relation of one on multiple as to license file numbers for transfer. Accordingly, multiple license file numbers may exist as to the same license file.

The license file table 1431 for transfer stores a license file number 1432 for transfer, license file 1433 for transfer, application ID 1434, transfer-source license file number 1435, and transfer-destination device serial number 1436. An application ID has a relation of one on multiple as to license file numbers. Accordingly, multiple transfer license file numbers may exist as to the same application ID.

A device product information table 5720 stores a device product code 5721 which is unique as to a product, target model product name 5722, editing lock flag 5723 indicating that modification of the content is prohibited depending on the issuance state of LA#, device product overview 5724, and so forth. A later-described machine number data band information table 5780 has a relation of one on multiple as to the device product information table 5720. Accordingly, multiple machine number data bands may exist as to the same device product.

The machine number data band information table 5780 stores a device product code 5781, sequence number 5782, and data band prefix 5783. Further, the machine number data band information table 5780 stores a data band start number 5784, data band end number 5785, editing lock flag 5786, destination region 5787, and so forth. A table 5810, which correlates an application with a device product, stores an application ID 5811, and device product code 5812. An application ID has a relation of one on multiple as to device products. Accordingly, multiple device products may exist as to the same application ID.

### Registration of Application Product to License Information Issuance Server 101

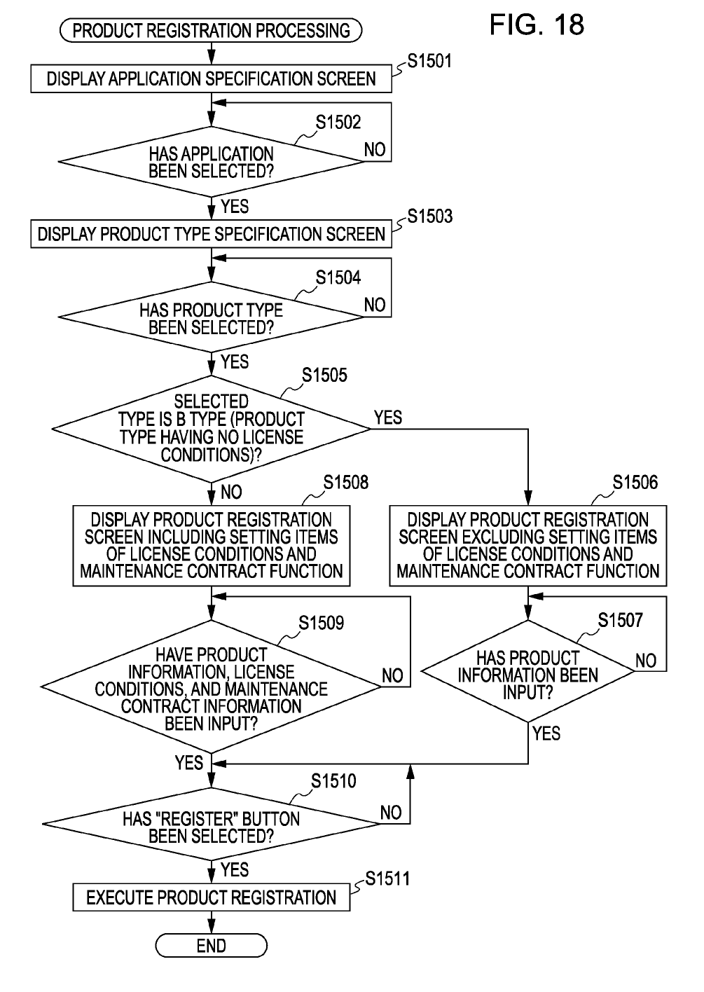

FIG. 18 is a flowchart for describing an example of processing at the network system when registering a product to which a license is added to the license information issuance server 101. Upon predetermined product registration processing start operations being performed at the seller terminal 103, the flowchart shown in FIG. 18 is activated.

First, in step S1501, the seller terminal 103 displays the product registration application specification screen 301 shown in FIG. 6. Next, in step S1502, the seller terminal 103 stands by until the operator of the sales company selects the “Product Registration” button 303, and selects an application. Upon the application being selected, the processing proceeds to step S1503.

In step S1503, the seller terminal 103 displays the product type specification screen 401 shown in FIG. 7. Next, in step S1504, the seller terminal 103 stands by until the operator of the sales company selects a product type, and then selects the “Next” button 403. Subsequently, following a product type being selected, upon the “Next” button 403 being selected, the processing proceeds to step S1505. In step S1505, the seller terminal 103 determines whether or not the selected product type is B type (product type specifying no license condition).

In the case of the product type of B type being selected as a result of this determination, the processing proceeds to step S1506. Subsequently, the seller terminal 103 displays the product registration screen 1101 excluding the setting items of license conditions and maintenance contract function (see FIG. 14). Next, in step S1507, the seller terminal 103 stands by until product information (product name and product code) is input to the product registration screen 1101. Upon the product information being input, the processing proceeds to later-described step S1510.

In a case wherein determination is made in step S1505 that the product type of B type has not been selected, the processing proceeds to step S1508. Subsequently, the seller terminal 103 displays the product registration screen 501 including the setting items of license conditions and maintenance contract function (see FIG. 8). Next, in step S1509, the seller terminal 103 stands by until product information (product name and product code), license conditions, and maintenance contract information are input to the product registration screen 501. Upon the product information, license conditions, and maintenance contract information being input, the processing proceeds to step S1510.

In step S1510, the seller terminal 103 stands by until the “Register” buttons 521 and 1106 are selected. Upon the “Register” buttons 521 and 1106 being selected, the processing proceeds to step S1511, where the seller terminal 103 performs product registration based on the information determined to have been input in steps S1507 and S1509. Subsequently, the processing according to the flowchart shown in FIG. 18 ends.

### Registration of Device Product to License Information Issuance Server 101

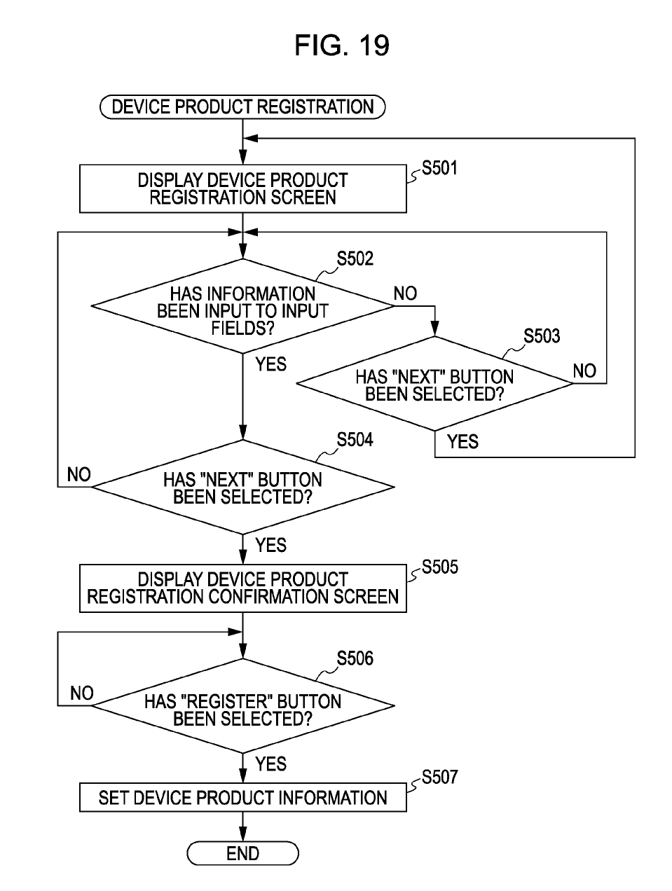

FIG. 19 is a flowchart for describing an example of processing at the network system when the license information issuance server 101 registers a device product. Upon predetermined device product registration processing start operations being performed at the seller terminal 103, the flowchart shown in FIG. 19 is activated.

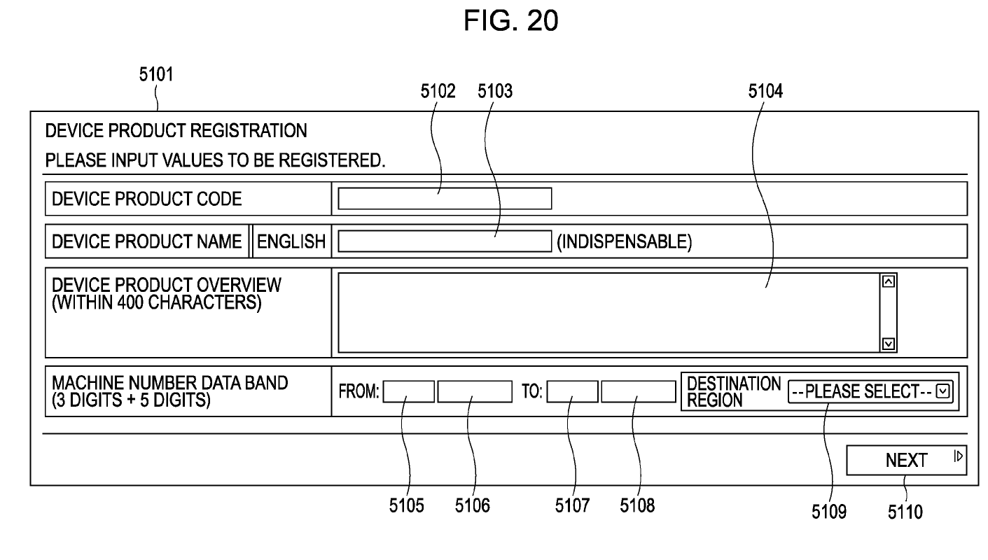

First, in step S501, the seller terminal 103 displays a device product registration screen 5101 for registering a device product (see FIG. 20). On the device product registration screen 5101, input fields such as a device product code 5102, device product name 5103, a product overview 5104, machine number data band prefixes 5105 and 5107, machine number data band start number 5106, machine number data band end number 5108, and so forth, are displayed. Also, on the device product registration screen 5101 a destination region list box 5109 for specifying a selectable destination region already registered is displayed. Further, on the device product registration screen 5101 a “Next” button 5110 to be selected when input is completed is displayed. Now, the machine number data band represents the array of the serial numbers of the devices 170 and 171. This machine number data band is employed for determination of a later-described destination region, and so forth. The term “destination region” means the sales region of a device product, option product, and application. Multiple sales company names are registered as destination regions beforehand.

Next, in step S502, the seller terminal 103 stands by until necessary information is input to the input fields displayed on the device product registration screen 5101. In the case of no information being input to the input fields, the processing proceeds to step S503, where the seller terminal 103 determines whether or not the “Next” button 5110 has been selected. In the case of the “Next” button 5110 having not been selected as a result of this determination, the processing returns to step S502. On the other hand, in the case of the “Next” button 5110 having been selected, the processing returns to step S501. In this case, the “Next” button 5110 has been selected without suitable input, so the seller terminal 103 displays the same screen as the currently displayed device product registration screen 5101 again.

Upon the necessary information being input to the input field displayed on the device product registration screen 5101 in step S502, the processing proceeds to step S504. Subsequently, the seller terminal 103 determines whether or not the “Next” button 5110 has been selected. In the case of the “Next” button 5110 having not been selected as a result of this determination, the processing returns to step S502. On the other hand, in the case of the “Next” button 5110 having been selected, the processing proceeds to step S505.

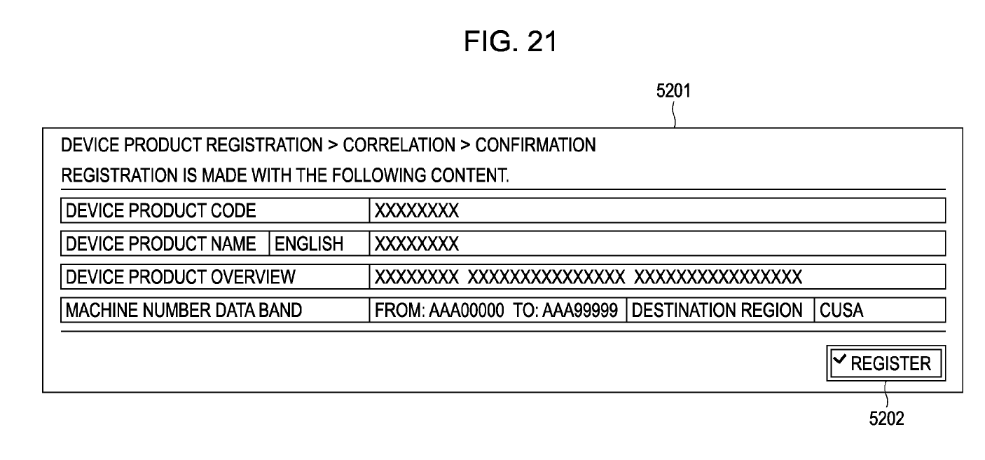

Upon the processing proceeding to step S505, the seller terminal 103 displays data input to the device product registration screen 5101 on the device product registration confirmation screen 5201 (see FIG. 21). The user confirms the registration content displayed on the device product registration confirmation screen 5201. In step S506, the seller terminal 103 stands by until a “Register” button 5202 is selected. Upon the “Register” button 5202 having been selected, the seller terminal 103 instructs the license information issuance server 101 to record the information of the registered device product in the license information database 106. Thus, the license information issuance server 101 registers the device product information. Subsequently, the processing of the flowchart shown in FIG. 19 ends.

### Registration of Option Product to License Information Issuance Server 101

### Description of Product Registration Settings (Product Registration Section 107)

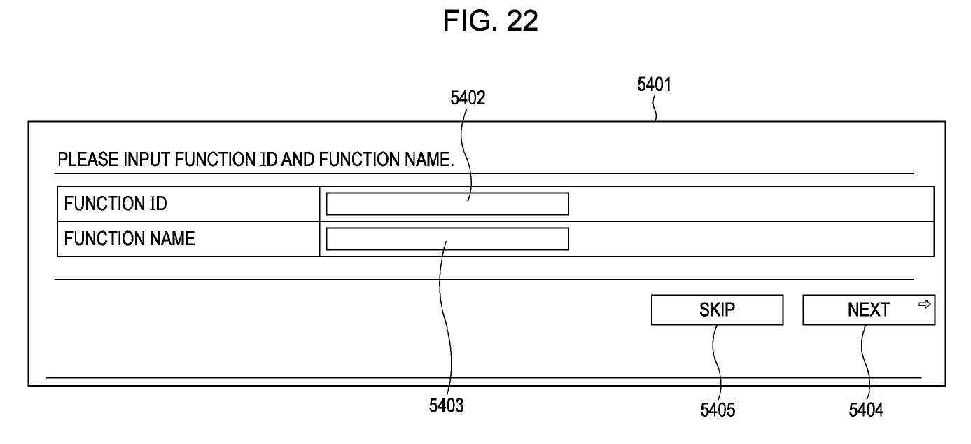

FIGS. 22 through 24 are input screens for registering the option products provided by the license information issuance server 101. When receiving access from the manufacturer terminal 104 through the network 105, the license information issuance server 101 transmits image data for displaying the input screens shown in FIGS. 22 through 24 to the manufacturer terminal 104.

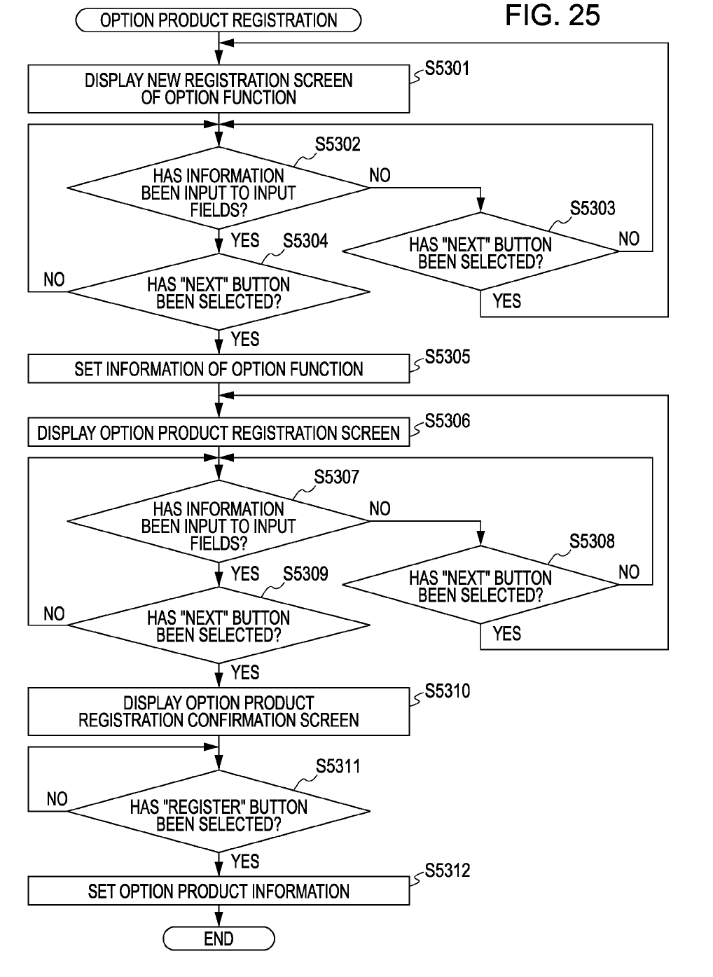

FIG. 25 is a flowchart for describing an example of processing at the network system when the license information issuance server 101 registers an option product. First, upon the license information issuance server 101 being logged in through the network 105, the manufacturer terminal 104 displays an operation menu (not shown). Examples of this operation menu include a product reference menu or the like whereby product registration can be selected, and a product already set can be referenced or modified. Upon product registration being selected from this operation menu, the processing in accordance with the flowchart shown in FIG. 25 is started.

First, in step S5301, the manufacturer terminal 104 displays a new option function registration screen 5401 (see FIG. 22). On the new option function registration screen 5401 a function ID input field 5402, a function name input field 5403, “Next” button 5404, and “Skip” button 5405 are displayed. In step S5302, the manufacturer terminal 104 determines whether or not a device ID and device name have been input to the function ID input field 5402 and function name input field 5403, respectively. In the case of a device ID and device name having been input to the function ID input field 5402 and function name input field 5403 as a result of this determination respectively, the processing proceeds to later-described step S5305.

On the other hand, in the case of a device ID and device name having not been input to the function ID input field 5402 and function name input field 5403 respectively, the processing proceeds to step S5303. Subsequently, the manufacturer terminal 104 determines whether or not the “Next” button 5404 has been selected. In the case of the “Next” button 5404 having not been selected as a result of this determination, the processing returns to step S5302. On the other hand, in the case of the “Next” button 5404 having been selected, the processing returns to step S5301. In this case, the “Next” button 5404 has been selected without suitable input, so the processing returns to step S5301, where the manufacturer terminal 104 displays the same screen as the currently displayed device product registration screen 5101 again.

In the case of determination that a device ID and device name have been input to the function ID input field 5402 and function name input field 5403 in step S5302 respectively, the processing proceeds to step S5304. Upon the processing proceeding to step S5304, the manufacturer terminal 104 determines whether or not the “Next” button 5404 has been selected. In the case of the “Next” button 5404 having not been selected as a result of this determination, the processing returns to step S5302. On the other hand, in the case of the “Next” button 5404 having been selected, the processing proceeds to step S5305.

Upon the processing proceeding to step S5305, the manufacturer terminal 104 executes processing for storing the information input to the new option function registration screen 5401 in the device management database 181. Thus, the device managing server 180 stores the information input to the new option function registration screen 5401 in the device management database 181.

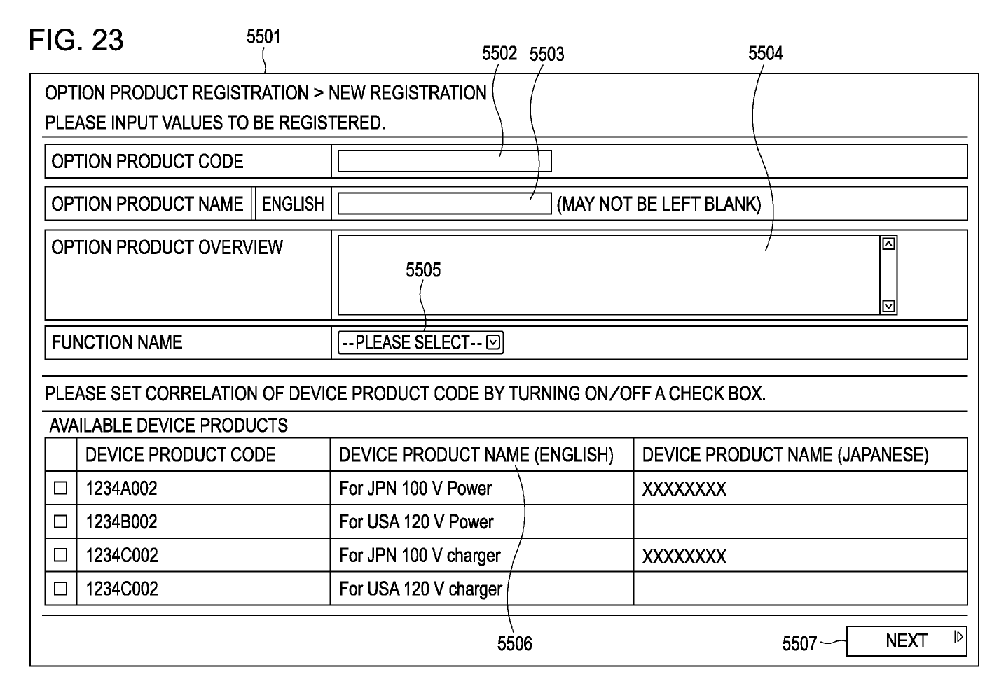

Next, in step S5306, the manufacturer terminal 104 displays an option product registration screen 5501 for registering an option product (see FIG. 23). On the option product registration screen 5501 an option product code input field 5502, option product name input field 5503, and product overview input field 5504 are displayed. Further, on the option product registration screen 5501 an option function name selection field 5505, and selectable already-registered device product input field 5506 are displayed. Multiple device products can be selected at the device product input field 5506. On the option product registration screen 5501 a “Next” button 5507 to be selected at the time of completion of input is also displayed.

In step S5307, the manufacturer terminal 104 determines whether or not necessary information has been input to the respective fields 5502 through 5506 of the option product registration screen 5501, and also whether a device product has been selected at the device product input field 5506. In a case wherein the necessary information has been input, and also a device product has been selected as a result of this determination, the processing proceeds to later-described step S5309.

On the other hand, in the case of the necessary information having not been input, or in the case of a device product having not been selected, the processing proceeds to step S5308. Subsequently, the manufacturer terminal 104 determines whether or not the “Next” button 5507 has been selected. In the case of the “Next” button 5507 having not been selected as a result of this determination, the processing returns to step S5307. On the other hand, in the case of the “Next” button 5507 having been selected, the processing returns to step S5306. In this case, the “Next” button 5507 has been selected without suitable input, so the processing returns to step S5306, where the manufacturer terminal 104 displays the same screen as the currently displayed option product registration screen 5501 again.

In a case wherein determination is made that the necessary information has been input, and also a device product has been selected, the processing proceeds to step S5309. Upon the processing proceeding to step S5309, the manufacturer terminal 104 determines whether or not the “Next” button 5507 has been selected. In the case of the “Next” button 5507 having not been selected as a result of this determination, the processing returns to step S5307. On the other hand, in the case of the “Next” button 5507 having been selected, the processing proceeds to step S5310.

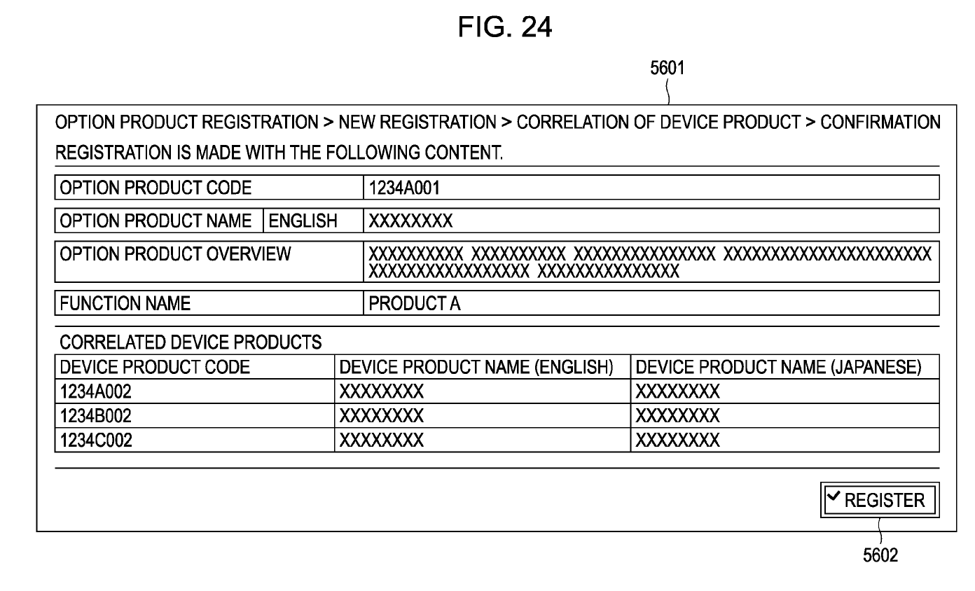

Upon the processing proceeding to step S5310, the manufacturer terminal 104 displays an option product registration confirmation screen 5601 (see FIG. 24). Next, in step S5311, the manufacturer terminal 104 stands by until a “Register” button 5602 is selected. In the case of the “Register” button 5602 having not been selected, the processing returns to step S5307. On the other hand, in the case of the “Next” button 5507 having been selected, the processing proceeds to step S5310.

Upon the processing proceeding to step S5310, the manufacturer terminal 104 executes processing for storing the information displayed on the option product registration confirmation screen 5601 in the device management database 181. Thus, the device managing server 180 stores the information displayed on the option product registration confirmation screen 5601 in the device management database 181. Subsequently, the processing of the flowchart shown in FIG. 25 ends.

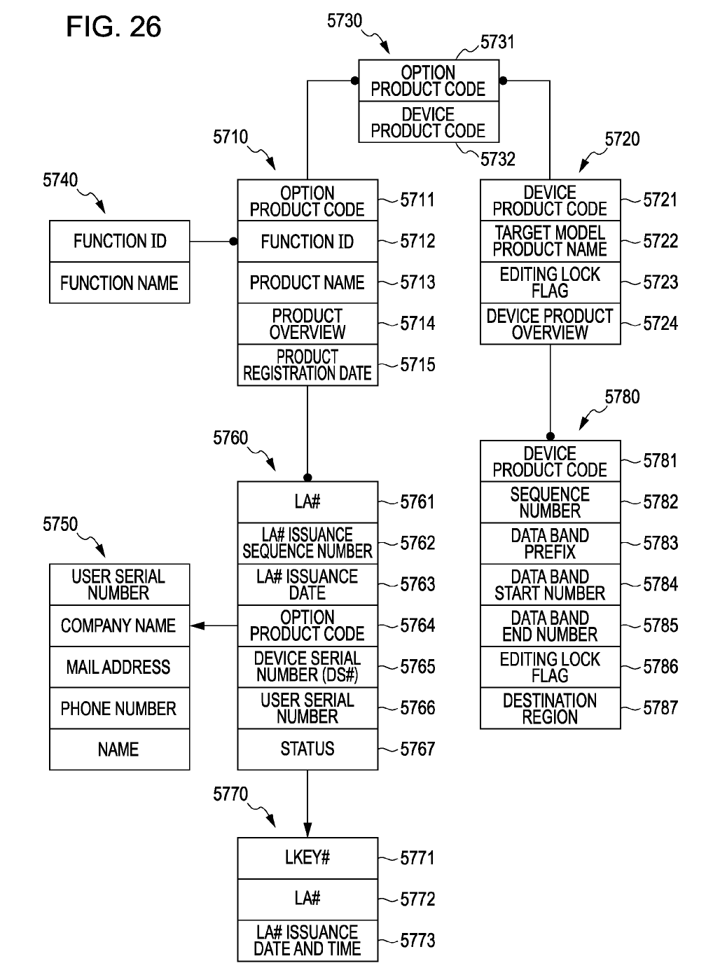

FIG. 26 is a diagram illustrating an example of information to be stored in the license information management database 106 in a simplified manner. The license information management database 106 stores an option product information table 5710, and device product information table 5720. The option product information table 5710 and device product information table 5720 have a relation of multiple on multiple. Accordingly, the license information management database 106 stores a table 5730 which correlates the option product information table 5710 with the device product information table 5720. Also, the license information management database 106 stores a function information table 5740, customer information table 5750, license access number information table 5760, license key information table 5770, and machine number information table 5780.

The function information table 5740 stores a function ID 5741 and function name 5742 for classifying and identifying the option functions as to the devices 170 and 171. An option product has a relation of one on multiple as to the function information (function ID 5741 and function name 5742). Accordingly, a plurality of function information may exist as to the same option product. The option product information table 5710 stores an option product code 5711 which is unique on the network system, function ID 5712 indicating an option function classification, product name 5713, product overview 5714, and product registration date 5715.

The license access number information table 5760 has a relation of one on multiple as to option products. Accordingly, multiple license access numbers may exist as to the same option product. The license access number information table 5760 stores a license access number (LA#) 5761, license access number issuance sequence number 5762, license access number issuance date 5763, and option product code 5764. Further, the license access number information table 5760 stores a device serial number (DS#) 5765, user serial number 5766, status 5767 indicating a license valid/invalid status.

The customer information table 5750 stores a user serial number 5751, company name 5752, mail address 453, phone number 5754, and name 5755. The license key (LKEY) information table 5770 stores a license key number (LKEY#) 5771, license access number (LA#) 5772, and license access number issuance date and time 5773. Note that the device product information table 5720 and machine number data band information table 5780 are the same as those shown in FIG. 17.

The device product information table 5720 stores a device product code 5721 which is unique to a product, target model product name 5722, and editing lock flag 5723 indicating that modification of the content is prohibited depending on the issuance state of a license access number (LA#). Further, the device product information table 5720 stores a device product overview 5724, and so forth. The device product information table 5720 has a relation of one on multiple as to the machine number data band information table 5780. Accordingly, multiple machine number data bands may exist as to the same device product.

The machine number data band information table 5780 stores a device product code 5781, sequence number 5782, data band prefix 5783, and data band start number 5784. Further, the machine number data band information table 5780 stores a data band end number 5785, editing lock flag 5786, destination region 5787, and so forth. A table 5730, which correlates an option product with a device product, stores an option product code 5731, and device product code 5732. Option products and device products have a relation of one on multiple, so multiple device products may exist as to the same option product.

### Issuance of Software Identification Code of Application Product by License Information Issuance Server 101

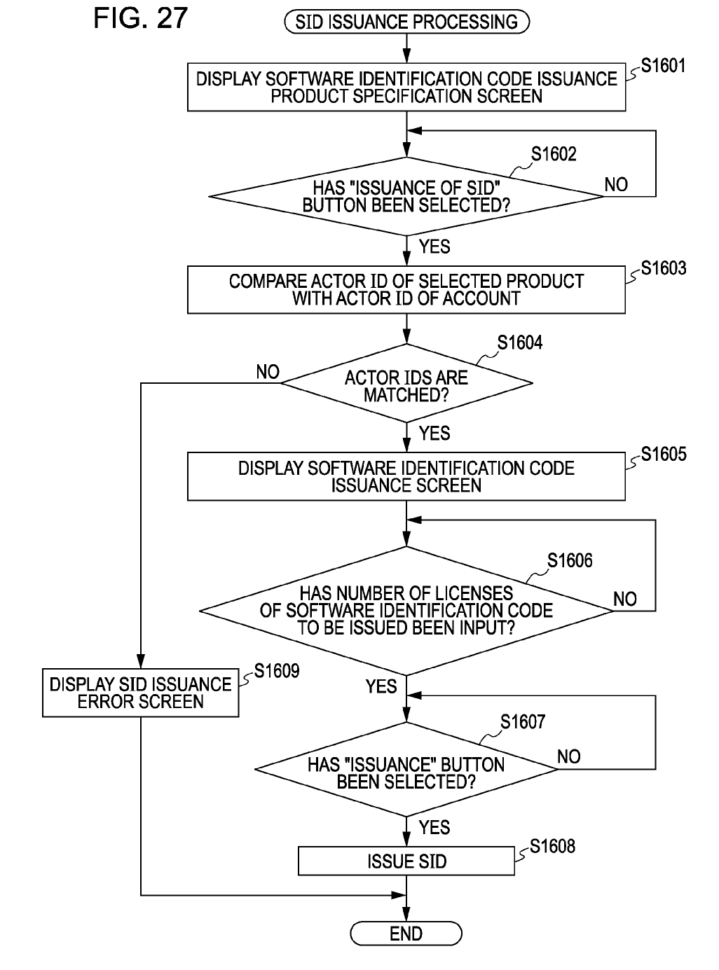

Next, description will be made regarding an example of software identification code issuance processing at the sales company or software developer with reference to the flowchart shown in FIG. 27. Upon the operator of the sales company or software developer performing predetermined operations for starting software identification code issuance processing, the flowchart shown in FIG. 27 is activated. Note that the processing performed by the seller terminal 103 will be described below as an example. Though description regarding the processing performed by the manufacturer terminal 104 will be omitted, the same processing can also be performed at the manufacturer terminal 104.

First, in step S1601, the seller terminal 103 displays the software identification code issuance product specification screen 601 as to an application serving as a software identification code issuance target (see FIG. 9). Next, in step S1602, the seller terminal 103 stands by until the “Issuance of SID” button 604 is selected. Upon the “Issuance of SID” button 604 having been selected, the processing proceeds to step S1603.

Upon the processing proceeding to step S1603, the license information issuance server 101 compares, based on the login ID of the sales company and the product selected at the software identification code issuance product specification screen 601, the selected product with the actor ID of the operator account. This comparison is performed by comparing the actor ID which is the attribute information of application software included in an application product with the actor ID of the operator performing a software identification code issuance operation at the time of issuing a software identification code. Subsequently, only in a case wherein the sales entity of the operator performing a software identification code issuance operation is identical to the sales entity of application software included in an application product, issuance of the software identification code is permitted. Thus, with the present embodiment, there is provided a limit as to issuance of a software identification code, whereby a software identification code can be prevented from being issued to an application product of which the sales entity differs from an operator requesting issuance of the software identification code.

In step S1603, the license information issuance server 101 references the information shown in FIGS. 5 and 17. That is to say, the license information issuance server 101 obtains the actor ID 5003 of the account table 5001 as the actor ID of the operator. On the other hand, the seller terminal 103 searches the application registration number 1402 of the application table 1401 identical to the application registration number 1409 within the product table 1407. Subsequently, the license information issuance server 101 obtains the actor ID 1406 correlated with the application registration number 1402 as the actor ID of the selected product.

Subsequently, in step S1604, the license information issuance server 101 determines whether or not the actor ID of the operator is identical to the actor ID of the product selected at the software identification code issuance product specification screen 601. In a case where the actor IDs do not match as a result of this determination, the processing proceeds to step S1609. Upon the processing proceeding to step S1609, the seller terminal 103 displays an SID issuance error screen (not shown), and the processing according to the flowchart shown in FIG. 27 ends.

On the other hand, in a case wherein the actor IDs match, the processing proceeds to step S1605. Upon the processing proceeding to step S1605, the seller terminal 103 displays the software identification code issuance screen 701 (see FIG. 10). Next, in step S1606, the seller terminal 103 stands by until the number of licenses of a software identification code to be issued is input. Upon the number of licenses of a software identification code to be issued being input, the processing proceeds to step S1607, where the seller terminal 103 stands by until the “Issuance” button 705 is selected. Upon the “Issuance” button 705 having been selected, the processing proceeds to step S1608, where the license information issuance server 101 issues the software identification code. Subsequently, the processing according to the flowchart shown in FIG. 27 ends.

### Issuance of License Information of Application Product by License Information Issuance Server 101

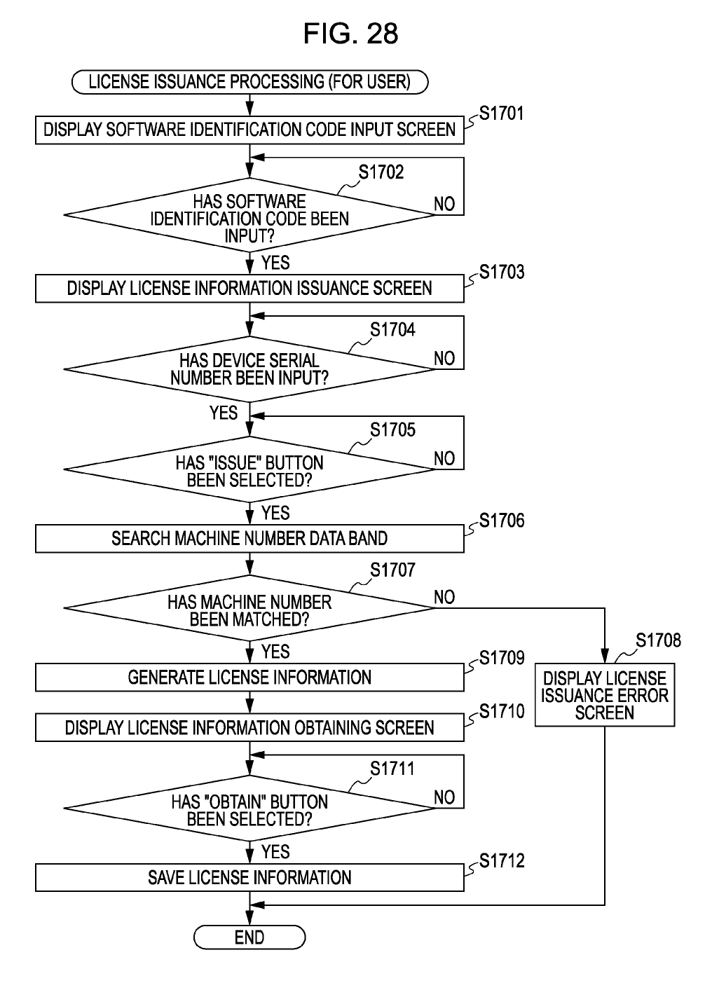

Next, description will be made regarding an example of license information issuance processing with reference to the flowchart shown in FIG. 28. Upon the user performing predetermined operations for starting the license information issuance processing, the flowchart shown in FIG. 28 is activated.

First, in step S1701, the user terminal 102 displays the software identification code input screen 801 (see FIG. 11). Next, in step S1702, the user terminal 102 stands by until the user inputs a software identification code. Upon a software identification code being input, the processing proceeds to step S1703.

Upon the processing proceeding to step S1703, the user terminal 102 displays the license information issuance screen 901. Next, in step S1704, the user terminal 102 stands by until the user inputs a device serial number to the device serial number input boxes 902. Upon a device serial number having been input, the processing proceeds to step S1705. Upon the processing proceeding to step S1705, the user terminal 102 stands by until the user selects the “Issue” button 906. Upon the “Issue” button 906 having been selected, the user terminal 102 instructs the license information issuance server 101 to issue license information (file).

Subsequently, in step S1706, the license information issuance server 101 searches a machine number data band based on the software identification code determined to have been input in step S1702, and the device serial number determined to have been input in step S1704.

Now, description will be made regarding an example of a machine number data band search method at the time of issuing license information. Determination is made regarding whether or not the device serial number input by the user at the time of issuing license information is in the range of a machine number data band corresponding to the software identification code input by the user at the time of issuing license information. This is for restricting issuance of license information such that an application for a certain destination region is not installed in a device for another destination region. Specifically, in step S1706, the license information issuance server 101 references the information stored in the license information management database 106 (see FIG. 17). That is to say, the license information issuance server 101 searches the software identification code input by the user from the software identification code table 1420. Subsequently, the license information issuance server 101 references the product code 1422 correlated with the searched software identification code. Further, the license information issuance server 101 references the product table 1407 based on the referenced product code 1422 to search the record matched with the product code thereof.

Similarly, the license information issuance server 101 searches the application registration number 1402 and application ID 1403 of the application table 1401. Subsequently, the license information issuance server 101 searches the device product code 5812 based on the searched application ID 1403, and the application ID 5811 of the table 5810 correlating the searched application ID 1403 with the device product code. Further, the license information issuance server 101 searches the data band start number 5784 of the machine number data band information table 5780, and data band end number 5785 based on the device product code 5812.

Thus, the license information issuance server 101 obtains the data band start number 5784 corresponding to the software identification code input by the user, and data band end number 5785.

Next, in step S1707, the license information issuance server 101 determines whether or not the device serial number input by the user exists between the obtained data band start number 5784 and data band end number 5785. In a case wherein the device serial number input by the user exists between the obtained data band start number 5784 and data band end number 5785, license information can be issued. In a case wherein the device serial number input by the user has been found to not exist between the obtained data band start number 5784 and data band end number 5785 as a result of the determination, the processing proceeds to step S1708. Upon the processing proceeding to step S1708, the user terminal 102 displays a license issuance error screen (not shown), and the processing according to the flowchart shown in FIG. 28 ends.

On the other hand, in a case wherein the device serial number input by the user exists between the obtained data band start number 5784 and data band end number 5785, determination is made that issuance of license information is instructed, the processing proceeds to step S1709. Upon the processing proceeding to step S1709, the license information issuance server 101 generates license information. Next, in step S1710, the user terminal 102 displays the license information obtaining screen (see FIG. 13). Next, in step S1711, the user terminal 102 stands by until the user selects the “Obtain” button 1002. The “Obtain” button 1002 is a button selected by the user to obtain the generated license information.

Next, in step S1712, the user terminal 102 displays a file specification dialog box provided in the operating system as a standard tool. Upon an arbitrary save destination and the file name thereof having been input to the file specification dialog box, the user terminal 102 saves the license information by adding the input file name thereto in the input save destination. Subsequently, the processing according to the flowchart shown in FIG. 28 ends.

Note that, with the present embodiment, description has been made regarding a case wherein the license information issuance server 101 directly issues license information to the user. Note however, a method for issuing license information is not restricted to this. For example, an arrangement may be made wherein the license information issuance server 101 issues license information to the software developer (manufacturer terminal 104), the issued license information may be transferred from the manufacturer terminal 104 to the user terminal 102.

### Issuance of License Information of Application Product by Sales Company or Software Developer

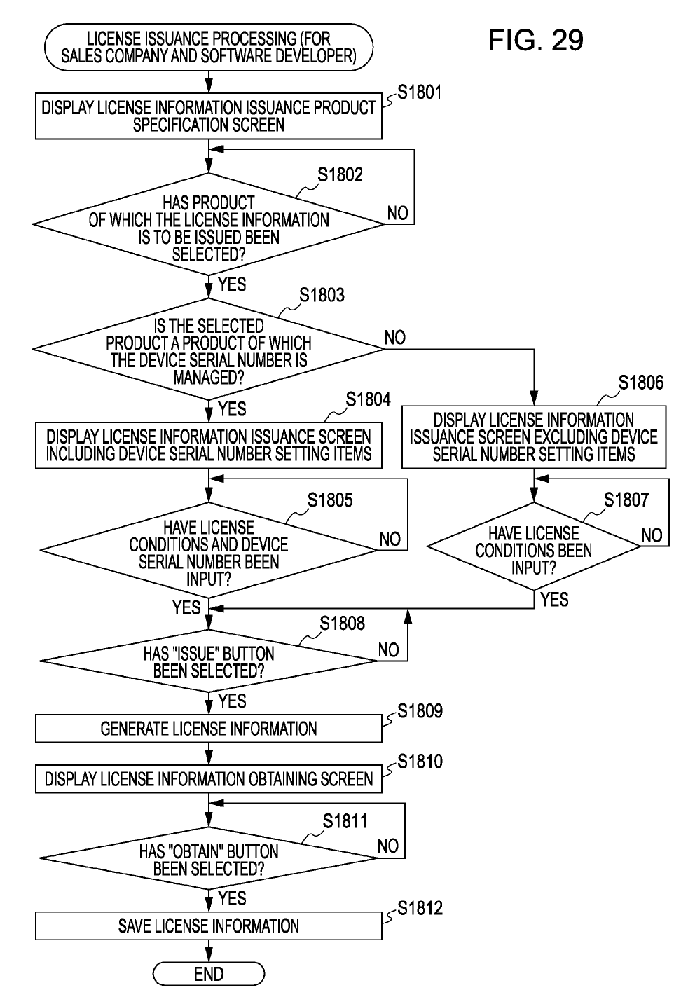

Next, description will be made regarding an example of license information issuance processing by the sales company or software developer with reference to the flowchart shown in FIG. 29. Note that description will be made below the processing performed by the seller terminal 103 as an example. Though description regarding the processing performed by the manufacturer terminal 104 will be omitted, the same processing can also be performed at the manufacturer terminal 104.

Upon the operator of the sales company performing predetermined operations for starting license information issuance processing, the flowchart shown in FIG. 29 is activated. First, in step S1801, the seller terminal 103 displays the license information file issuance target product specification screen 1201 as to an application serving as a license information issuance target (see FIG. 15).

Next, in step S1802, the seller terminal 103 stands by until the “Issuance of LF” button 1204 is selected, and a product of which the license information is to be issued is selected. Upon a product of which the license information is to be issued having been selected, the processing proceeds to step S1803. Upon the processing proceeding to step S1803, the seller terminal 103 determines whether or not the product of which the corresponding “Issuance of LF” button 1204 has been selected is a product of which the device serial number is managed.

In a case wherein the product of which the corresponding “Issuance of LF” button 1204 has been selected is not a product of which the device serial number is managed as a result of this determination, the processing proceeds to the later-described step S1806. On the other hand, in a case wherein the product of which the corresponding “Issuance of LF” button 1204 has been selected is a product of which the device serial number is managed, the processing proceeds to step S1804. Upon the processing proceeding to step S1804, the seller terminal 103 displays the license information file issuance screen 1301 including the setting items of the device serial number (see FIG. 16).

Next, in step S1805, the seller terminal 103 stands by until license conditions and a device serial number are input. Subsequently, upon license conditions and a device serial number having been input, the processing proceeds to later-described step S1808. In a case wherein determination is made in step S1803 that the product of which the corresponding “Issuance of LF” button 1204 has been selected is not a product of which the device serial number is managed, the processing proceeds to step S1806. Upon the processing proceeding to step S1806, the seller terminal 103 displays the license information issuance screen excluding the setting items of the device serial number.

Next, in step S1807, the seller terminal 103 stands by until license conditions are input. Upon license conditions having been input, the processing proceeds to step S1808. Upon the processing proceeding to step S1808, the seller terminal 103 stands by, for example, until the “Issue” button 1315 is selected. Upon the “Issue” button 1315 having been selected, the processing proceeds to step S1809, where the license information issuance server 101 generates license information. Next, in step S1810, the user terminal 102 displays the license information obtaining screen (see FIG. 13). Next, in step S1811, the user terminal 102 stands by until the “Obtain” button 1002 is selected. The “Obtain” button 1002 is a button selected by the user to obtain the generated license information.

Next, in step S1812, the user terminal 102 displays a file specification dialog box provided in the operating system as a standard tool. Upon an arbitrary save destination and the file name thereof having been input to the file specification dialog box, the user terminal 102 saves the license information by adding the input file name thereto in the input save destination. Subsequently, the processing according to the flowchart shown in FIG. 29 ends.

With the present embodiment, the user employs the license information thus issued to receive authentication, and installs the application product in the devices 170 and 171 which the user employs. Thus, a function can be added to the devices 170 and 171. License information is employed to perform authentication, whereby an application product can be prevented from being copied or installed illegally.

### Issuance of License Access Number of Option Product by License Information Issuance Server 101 (LA# Issuance Section 163)

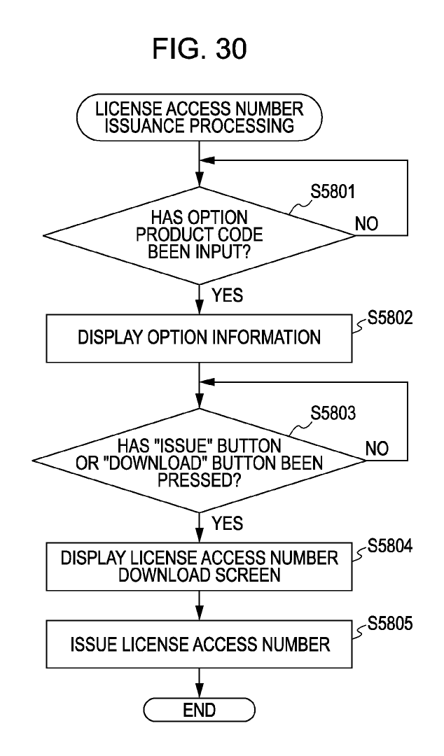

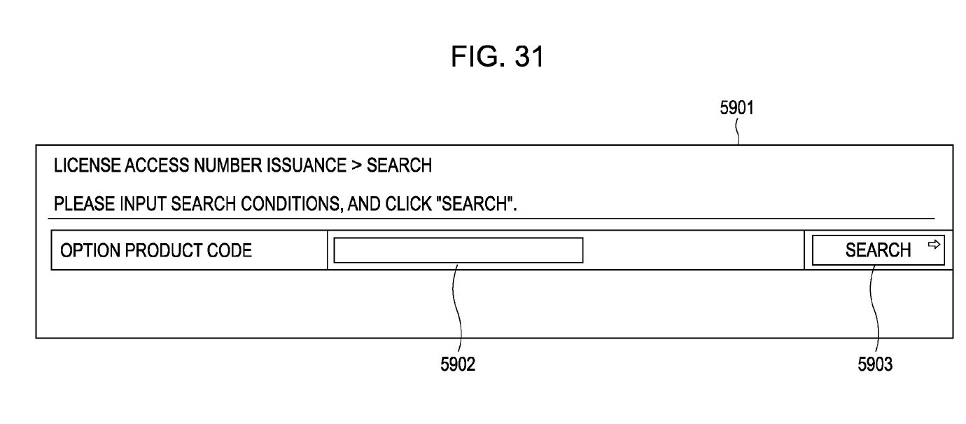

When receiving access from the seller terminal 103 through the network 105, the license information issuance server 101 transmits image data for displaying screens shown in FIGS. 31 through 33 to the seller terminal 103. Description will be made regarding an example of the processing at the network system at the time of issuing a license access number with reference to the flowchart shown in FIG. 30. Upon the seller terminal 103 logging in, the license information issuance server 101 transmits image data for displaying the screen 5901 shown in FIG. 31 to the seller terminal 103, and requests input of an option product code. FIG. 31 is a diagram illustrating an example of the screen 5901 for setting an option product. On this screen 5901 an option product code input field 5902, and search button 5903 are displayed. In step S5801, the seller terminal 103 stands by until the search button 5903 is pressed following an option product code being input.

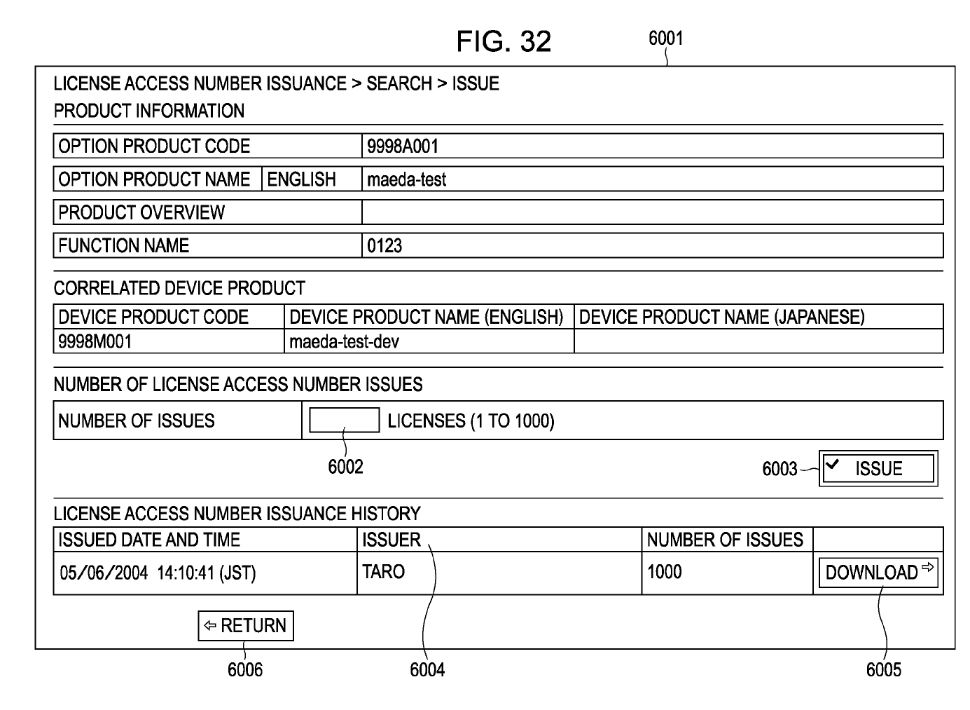

Upon the search button 5903 having being pressed after an option product code being input, the proceeding proceeds to step S5802. Upon the processing proceeding to step S5802, the seller terminal 103 displays a screen 6001 for displaying option information (see FIG. 32). In step S5802, the license information issuance server 101 obtains the option product code (option information) determined to have been input in step S5801. Next, the license information issuance server 101 extracts information relating to the option product code thereof from the license information management database 106, based on the obtained option product code. Next, the license information issuance server 101 generates image data for displaying the license number issuance screen 6001 shown in FIG. 32 based on the extracted information, and transmits the generated image data to the seller terminal 103.

On the license number issuance screen 6001 shown in FIG. 32 the following content is displayed in addition to the information relating to an option. That is to say, on the screen 6001 a field 6002 for specifying the number of issues for license access numbers (LA#), “Issue” button 6003, past issuance history display 6004, “Download” button 6005, and “Return” button 6006 are displayed. Note that the “Download” button 6005 is selected at the time of re-downloading a license access number issued in the past.

Next, in step S5803, the seller terminal 103 determines whether or not the “Issue” button 6003 or “Download” button 6005 has been selected. In a case wherein the “Issue” button 6003 or “Download” button 6005 has not been selected as a result of this determination, the processing returns to step S5803. On the other hand, in a case wherein the “Issue” button 6003 or “Download” button 6005 has been selected, the processing proceeds to step S5804. Upon the processing proceeding to step S5804, the license information issuance server 101 generates image data for displaying a license access number download screen 6101, and transmits this to the seller terminal 103 to request license issuance instructions. Subsequently, the seller terminal 103 displays the license access number download screen 6101.

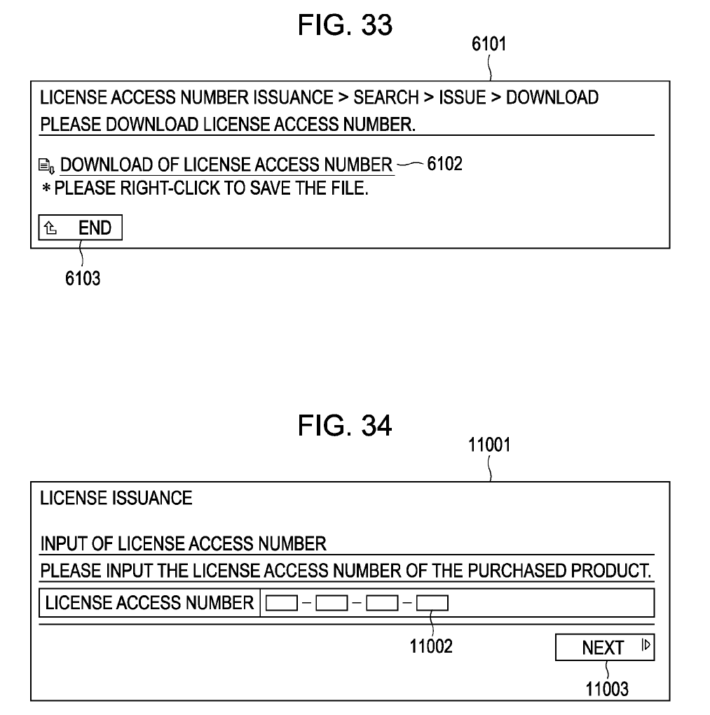

FIG. 33 is a diagram illustrating an example of the license access number download screen 6101. In step S5805, the license information issuance server 101 obtains the number of issues for license access numbers input to the screen 6001. Subsequently, the license information issuance server 101 generates the same number of license access tables as the obtained number of issues, and a license access number simultaneously. Subsequently, the license information issuance server 101 sets the generated license access number to the license access table. Further, the license information issuance server 101 saves the content of the generated license access table in a file format. The license information issuance server 101 prepares for image data including the link of the generated file. Subsequently, the license information issuance server 101 issues the license access number.

As shown in FIG. 33, on the license access number download screen 6101 there are provided a license access number download link 6102, and an “End” button 6103. Note that in a case wherein the “Download” button 6005 has been selected in step S5803, the license information issuance server 101 generates image data for displaying the download screen 6101 shown in FIG. 33 in the same way as with the case wherein the “Issue” button 6003 has been selected. Subsequently, the license information issuance server 101 transmits the generated image data to the seller terminal 103. Subsequently, the license information issuance server 101 prepares for image data including the link of a file generated in the past. Subsequently, the license information issuance server 101 issues the license access number again.

### Issuance of License Key of Option Product by License Information Issuance Server 101 (LKEY Issuance Module 157)

When receiving access from the user terminal 102 through the network 105, the license information issuance server 101 transmits image data for displaying screens shown in FIGS. 34 through 37 to the user terminal 102.

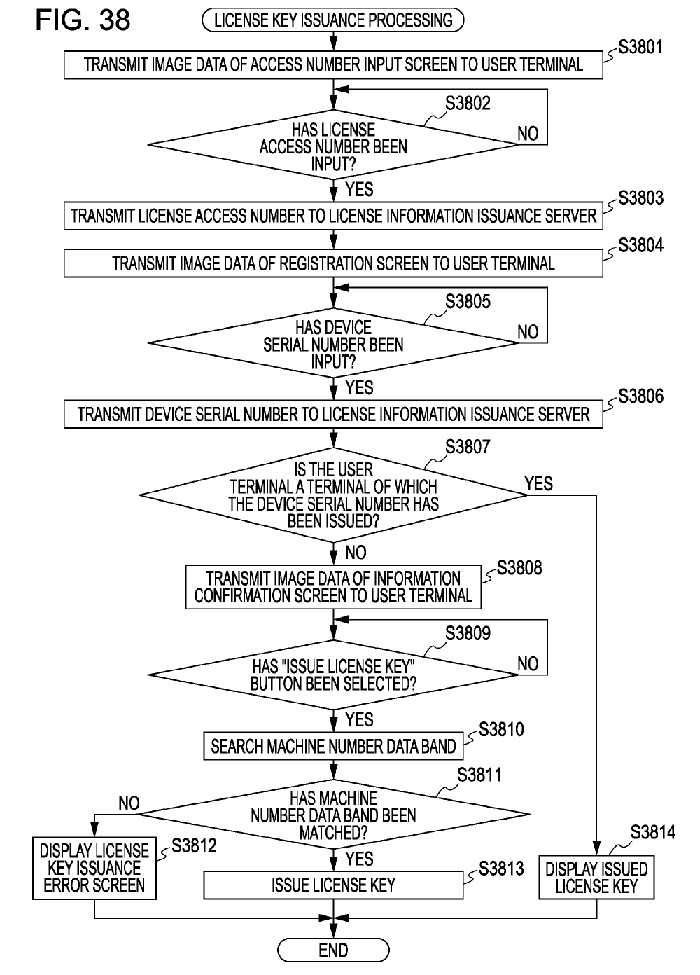

Description will be made regarding an example of processing at the network system at the time of issuing a license key with reference to the flowchart shown in FIG. 38. When requesting license information issuance, the user inputs the URL described in the purchased option package to the Web browser. Thus, the user terminal 102 employs the browser to access the URL described in the purchased option package. Thus, a request for issuing a license key is transmitted from the user terminal 102 to the license information issuance server 101.

The license information issuance server 101 which has received the request generates image data for displaying an access number input screen 11001 shown in FIG. 34 in step S3801, and transmits this to the user terminal 102 to request input of a license access number (LA#). On the access number input screen 11001 a license access number (LA#) input field 11002, and “Next” button 11003 are displayed.

Next, in step S3802, the user terminal 102 displays the access number input screen 11001. Subsequently, the user terminal 102 stands by until the “Next” button 11003 is pressed following the license access number (LA#) described in the purchased option package being input to the input field 11002. Upon a license access number having been input, the processing proceeds to step S3803, where the user terminal 102 transmits the license access number thereof to the license information issuance server 101.

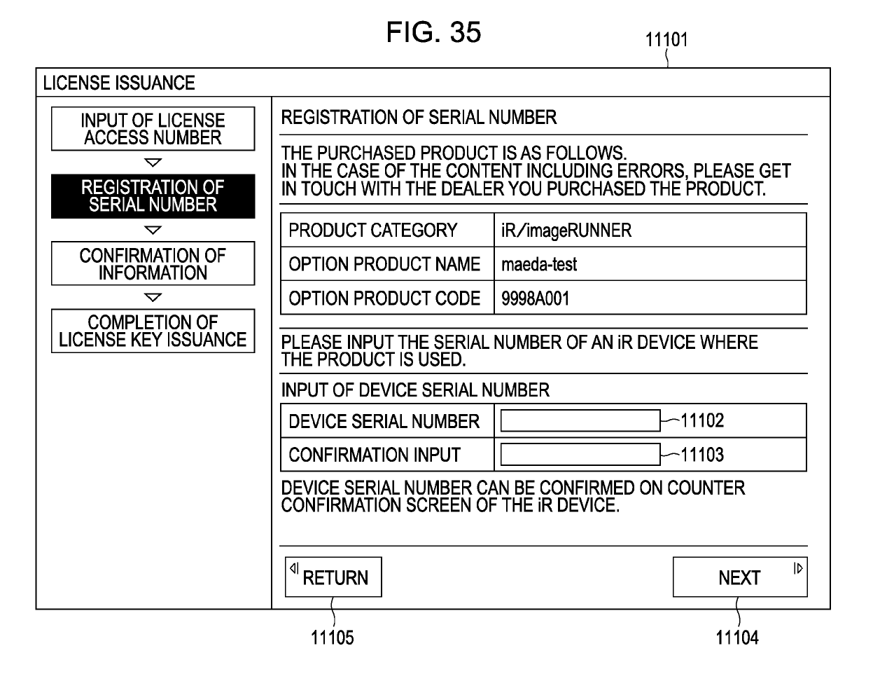

The license information issuance server 101 which has received the license access number searches the license access number information table 5760 (see FIG. 26) within the license information management database 106 in step S3804. Subsequently, the license information issuance server 101 extracts information relating to the option or product which is stored in a correlated manner with the obtained license access number (LA# 5761). Subsequently, the license information issuance server 101 employs the extracted information to generate image data for displaying a registration screen 11101 for requesting the serial number input shown in FIG. 35, and transmits this to the user terminal 102. On the registration screen 11101 a device serial number input field 11102, confirmation input field 11103, “Next” button 11104, and “Return” button 11105 are displayed.

Next, in step S3805, the user terminal 102 displays the registration screen 11101, and then stands by until device serial numbers are input to the input fields 11102 and 11103, and then the “Next” button 11104 is pressed. Upon the device serial numbers having been input, and the “Next” button 11104 having pressed, the processing proceeds to step S3806. Upon the processing proceeding to step S3806, the user terminal 102 transmits the input device serial number to the license information issuance server 101. The license information issuance server 101 which received the device serial number determines whether or not the received device serial number has already been issued to the user terminal 102 which transmitted the device serial number thereof.

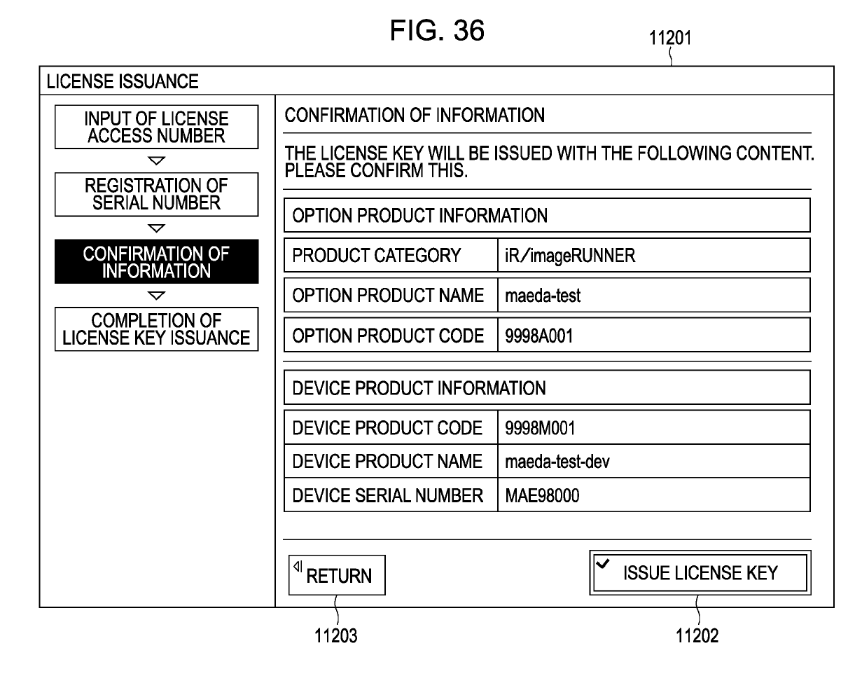

In a case wherein as a result of this determination the device serial number has already been issued, the processing proceeds to later-described step S3814. On the other hand, in a case wherein the device serial number has not been already issued, the processing proceeds to step S3808. Subsequently, the license information issuance server 101 generates image data for displaying an information confirmation screen 11201 which is a screen for allowing the user to confirm license issuance, and transmits this to the user terminal 102 (see FIG. 36). On the information confirmation screen 11201 an “Issue license key” button 11202 and “Return” button 11203 are displayed.

Next, in step S3809, the user terminal 102 displays the information confirmation screen 11201, and stands by until the “Issue license key” button 11202 is selected. Upon the “Issue license key” button 11202 having been selected, the processing proceeds to step S3810. Subsequently, in step S3811, the license information issuance server 101 searches a machine number data band based on the input software identification code and device serial number. The license information issuance server 101 determines whether or not the device serial number input by the user at the time of issuing a license key is within the range of the machine number data band corresponding to the license access number (LA#) input by the user. This determination is for restricting license key issuance so as to invalidate an option product for a certain destination region as to a device for another destination region.

Specifically, in step S3810, the license information issuance server 101 references the license information management database 106 in which the information shown in FIG. 26 is stored. That is to say, the license information issuance server 101 searches the license access number (LA#) input by the user from the license access number information table 5760, and references the option product code 5764 from the searched record. Further, the license information issuance server 101 references the option product information table 5710 from the referenced option product code 5764, and searches the record matched with the referenced option product code 5764. Subsequently, the license information issuance server 101 searches the device product code 5732 from the option product code 5731 within the table 5730 which correlates the option product information table 5710 with the device product information table 5720. Further, the license information issuance server 101 employs the searched device product code 5732 to search the device product code 5721 within the device product information table 5720. Subsequently, the license information issuance server 101 employs the searched device product code 5721 to search the data band stare number 5784 and data band end number 5785 within the machine number data band information table 5780.

According to the above processing, the license information issuance server 101 obtains the data band start number 5784 and data band end number 5785 as to the license access number (LA#) input by the user. Next, the license information issuance server 101 determines whether or not the device serial number input by the user exists between the obtained data band start number 5784 and data band end number 5785 (step S3811). In a case wherein the device serial number input by the user exists between the data band start number 5784 and data band end number 5785, a license key can be issued.

In a case wherein the device serial number input by the user does not exist between the data band start number 5784 and data band end number 5785 as a result of the determination in step S3811, the processing proceeds to step S3812. Subsequently, the license information issuance server 101 generates image data for displaying a license key issuance error screen (not shown), and transmits this to the user terminal 102. Subsequently, the user terminal 102 displays the license key issuance error screen. Subsequently, the processing according to the flowchart shown in FIG. 38 ends.

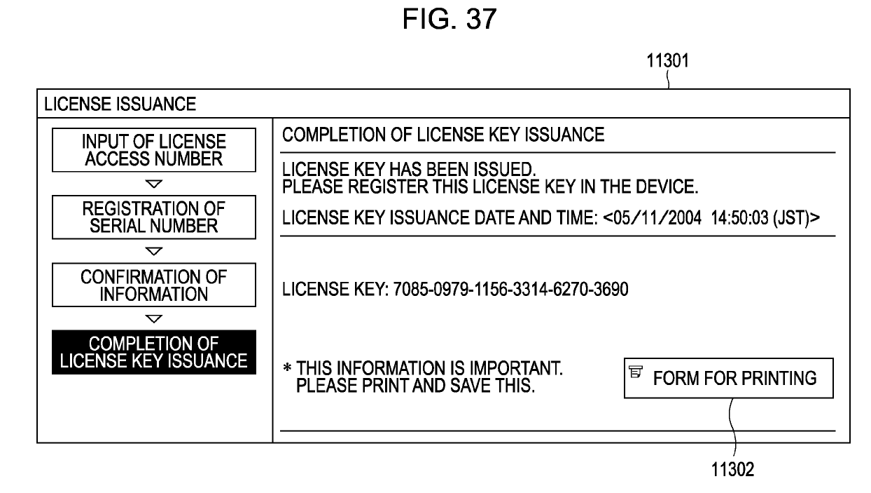

On the other hand, in a case wherein the device serial number input by the user exists between the data band start number 5784 and data band end number 5785, the processing proceeds to step S3813. Subsequently, the license information issuance server 101 employs information such as the device serial number which has been input, the option number which has been set, and so forth to generate an encrypted license key number (LKEY#), and registers this in the license information management database 106. Further, the license information issuance server 101 generates image data for displaying a screen 11301 for displaying the registered license key number (LKEY#), and transmits this to the user terminal 102. Subsequently, the user terminal 102 displays the screen 11301 for displaying a license key number. According to the processing in step S3813, a license key is issued. Note that as shown in FIG. 37, on the screen 11301 for displaying a license key number a “Form for printing” button 11302 is displayed, which is to be selected at the time of generating a screen having a size so as to be printed suitably from the browser.

In a case wherein determination is made in step S3807 that the device serial number has already been issued, the processing proceeds to later-described step S3814. Subsequently, the license information issuance server 101 employs information such as the device serial number which has been input, the option number which has been set, and so forth to obtain an already encrypted license key number (LKEY#) from the license information management database 106. Further, the license information issuance server 101 generates image data for displaying a screen 11301 for displaying a license key number (LKEY#), and transmits this to the user terminal 102. Subsequently, the user terminal 102 displays the screen 11301 for displaying a license key number. According to this processing in step S3814 a license key is issued.

The license key thus obtained by the license information issuance server 101 is input by the user's operations, for example, to the devices 170 and 171. Thus, the devices 170 and 171 are in a state wherein an option function based on the license key which has been input can be employed. The devices 170 and 171 to which the license key was input employs the devices serial number and option number set in the own devices to generate an encrypted license key number in the same way as with the license information issuance server 101 (see step S3813 shown in FIG. 38). Thus, the devices 170 and 171 compare the generated license key number with the license key number which has been input, and in the case of these being matched, an option function can be permitted. Thus, the devices 170 and 171 manufactured and sold, and an option function realized by the devices 170 and 171 thereof can be placed under the management of the license information issuance server 101. As described above, with the present embodiment, license information is realized by a license key number (LKEY#), and an issuing unit can be realized by executing the processing in accordance with the flowchart shown in FIG. 38.

Note here that description has been made regarding a case wherein the devices 170 and 171, and user terminal 102 are independent devices as an example. However, an arrangement may be made for example, wherein the above-mentioned function of the user terminal is included in a device having a configuration wherein input of browser and a license key (LKEY#) can be performed, whereby the device can be integral with the user terminal. Also, the order of the flowchart at the time of registering an option product, shown in FIG. 18, and the flowchart at the time of registering a device product, shown in FIG. 19 is interchangeable.

### Configuration Relating to Device Managing Server 180

Next, description will be made regarding the devices 170 and 171. Note that the devices 170 and 171 have the same configuration, so the device 170 alone will be described here, and the detailed description of the device 171 will be omitted.

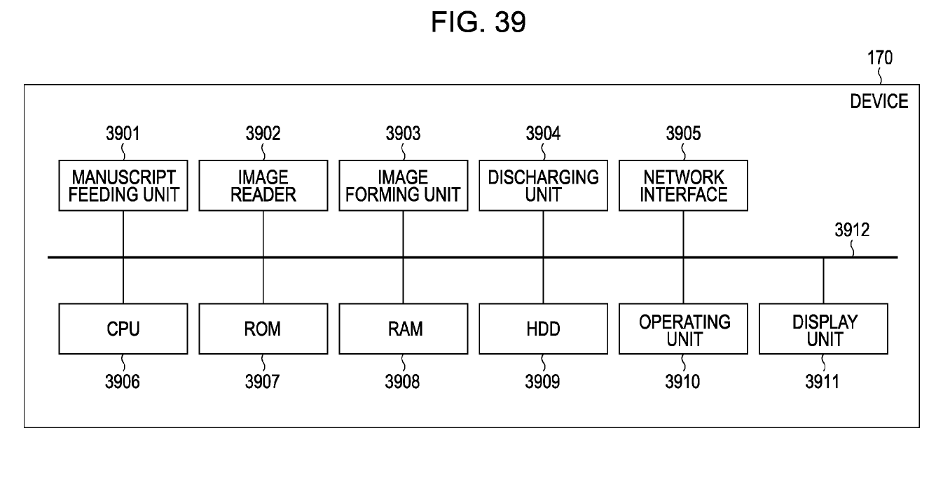

FIG. 39 is a diagram illustrating an example of the hardware configuration of the device 170. In FIG. 39, an original feeding unit 3901 feeds an original. An image reader 3902 reads in the original. An image forming unit 3903 converts the original read in by the image reader 3902, and the data received through a network interface 3905 into a printed image, and prints this. A discharging unit 3904 discharges printed sheets, and subjected these sheets to processing such as sorting or stapling. The network interface 3905 is connected to the networks 100 and 105 to perform exchange of information with an external device. A CPU 3906 executes a control program stored in ROM 3907 or HDD 3909 using RAM 3908. The ROM 3907 is a recording medium which is not rewritable, and stores a control program and data relating to the various types of processing of the device 170. The RAM 3908 is a rewritable recoding medium which can electrically store temporal data relating to various types of processing of the device 170. The HDD 3909 is a readable writable recoding medium which stores a control program and data relating to various types of processing of the device 170, temporal data, data transmitted to the device 170, and so forth. An operating unit 3910 is a device which accepts input of instructions for the device 170. A display unit 3911 is a computer display for displaying the operation status of the device 170, information relating to operations as to the operating unit 3910, and so forth. A system bus 3912 is for connecting the above-mentioned components 3901 through 3911 of the device 170 in a mutually communicable manner.

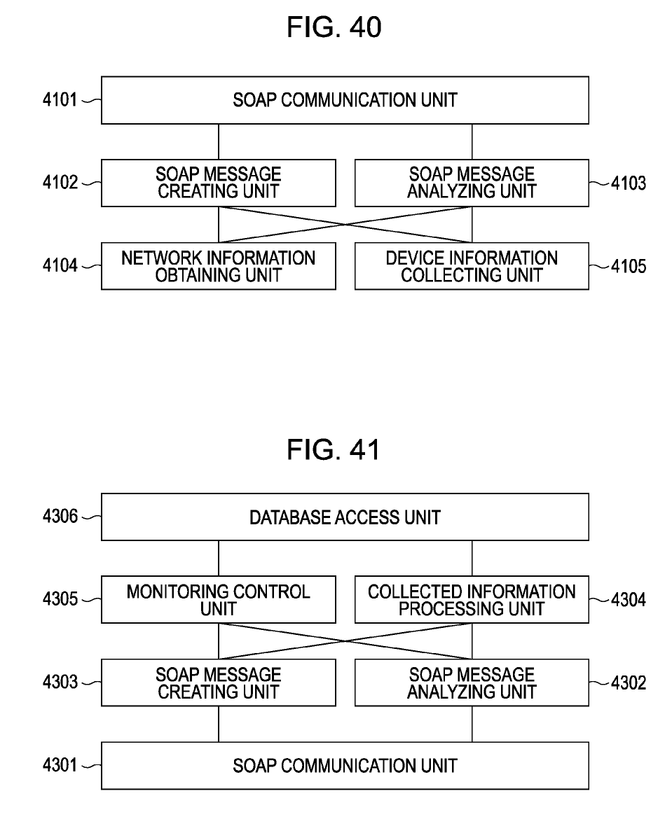

FIG. 40 is a diagram illustrating a functional configuration example of a portion relating to communication with the device managing server 180, of the functional configuration included in the device 170. In FIG. 40, an SOAP communication unit 4101 provides the SOAP data received from the device managing server 180 through the network interface 3905 to an SOAP message analyzing unit 4103. Also, the SOAP communication unit 4101 transmits the SOAP data created by an SOAP message creating unit 4102 to the device managing server 180 through the network interface 3905.

The network information obtaining unit 4104 can automatically obtain an IP address, DNS server and gateway addresses with a DHCP environment, for example. Also, in a case wherein there is network information input from the operating unit 3910, and saved in the HDD 3909, the network information obtaining unit 4104 obtains the network information thereof. The device information collecting unit 4105 obtains the counter information held in the device 170 in accordance with the schedule set by the device 170 itself or the instructions from the device managing server 180. Also, the device information collecting unit 4105 obtains failure information such as a service call, jamming, out of toner, and so forth generated within the device 170.

The device information collecting unit 4105 provides the obtained data to the SOAP message creating unit 4102 without change, whereby the obtained data can be transmitted to the device managing server 180. Also, the device information collecting unit 4105 subjects the obtained data to accumulation, interpretation, and processing within the device information collecting unit 4105, and provides this to the SOAP message creating unit 4102, whereby the processed data can also be transmitted to the device managing server 180.

For example, the failure information includes failure occurrence point-in-time, and an occurrence error number. Also, upon failure information having not been obtained, the device information collecting unit 4105 can determine that a failure has been eliminated. Accordingly, the device managing server 180 can also confirm that a failure has been eliminated. Also, in a case wherein the user has employed printing, copying, scanning functions, the device information collecting unit 4105 obtains number-of-sheet information indicating the number of employed sheets. Subsequently, the device information collecting unit 4105 outputs the obtained number-of-sheet information to the SOAP message creating unit 4102, whereby this information can be transmitted to the device managing server 180. Now, the term “number-of-sheet information” is information indicating, for example, how many number of printed A4 sheets, how many number of printed A3 sheets, and so forth.

Note that the monitoring device 182 has the same configuration as that of the user terminal 102 and seller terminal 103. Of the functions included in the monitoring device 182, the functional configuration of a portion relating to communication with the device managing server 180 is the same as that shown in FIG. 40.

FIG. 41 is a diagram illustrating a functional configuration example of a portion relating to communication with the devices 170 and 171, of the functional configuration of the device managing server 180. In FIG. 41, an SOAP communication unit 4301 provides the SOAP data received from the devices 170 and 171 through the network interface 3905 to an SOAP message analyzing unit 4302. Also, the SOAP communication unit 4301 transmits the SOAP data created by an SOAP message creating unit 4303 to the devices 170 and 171 through the network interface 3905.

A collected information processing unit 4304 stores the information as is received from the devices 170 and 171 under monitoring, or subjects the received information to processing to store this, in the device management database 181, via the database access unit 4306. Also, the collected information processing unit 4304 realizes a function relating to a remote monitoring system based on the information received from the devices 170 and 171 under monitoring, and the data stored in the device management database 181. The function relating to the remote monitoring system is, for example, aggregation of counter information, notice of error information to a service man in charge or customer side manager, and so forth.

A monitoring control unit 4305 performs schedule management for obtaining the information of the devices 170 and 171, and performs control of the monitoring content and monitoring method of the devices 170 and 171. Further, the monitoring control unit 4305 transmits various types of instructions to the devices 170 and 171 under monitoring through the SOAP message creating unit 4303, and SOAP communication unit 4301, as necessary.

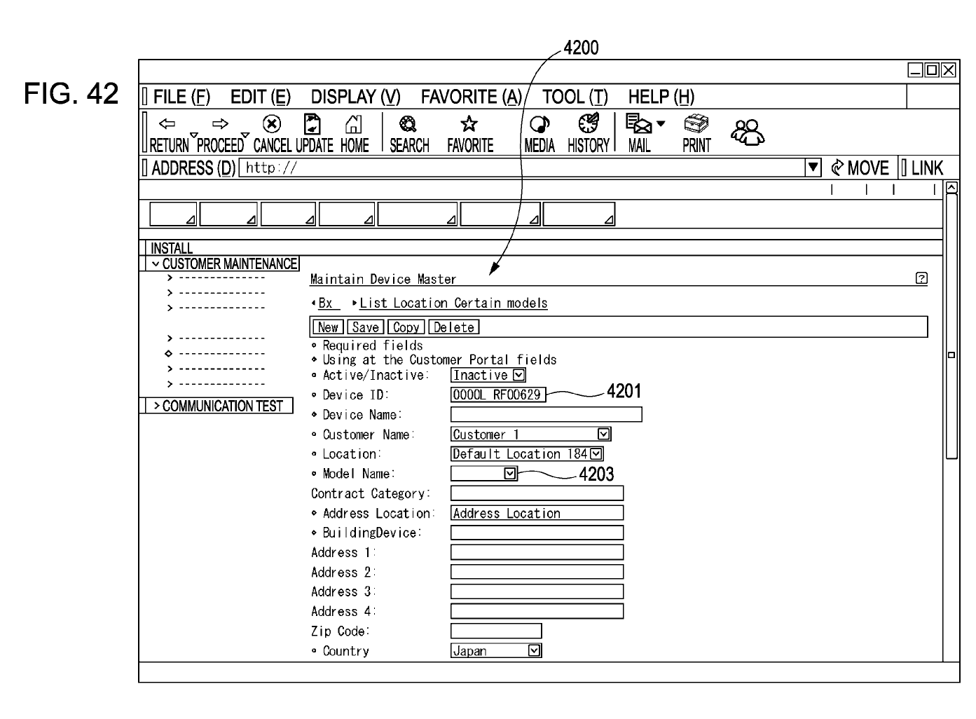

Next, description will be made regarding an example of settings for connecting the devices 170 and 171 or monitoring device 182 to the device managing server 180. FIG. 42 is a diagram illustrating an example of a setting registration screen prepared by the device managing server 180. In FIG. 42, the setting registration screen 4200 is a screen to be displayed at the user terminal 102 or the like. On the setting registration screen 4200 information necessary for communication can be set, a device ID input field 4201 for uniquely determining a device, and a product name input field 4203 are displayed. The device ID and product name of the devices 170 and 171 serving as management targets at the user terminal 102 or the like connectable to the network 105 are registered using the setting registration screen 4200.

The device managing server 180 receives reception data including the device ID that has been set at the setting registration screen 4200, for example, from the user terminal 102. Subsequently, the device managing server 180 determines whether or not the reception data is the reception data of which devices 170 and 171 based on the received device ID, and processes the received data. The data registered on the setting registration screen 4200 is stored in the device management database 181, and is referenced or updated as necessary. The device managing sever 180 regards only the received data of the device already registered in the device management database 181 as a processing target. Subsequently, the device managing server 180 stores only the received data of the device already registered in the device management database 181 in the device management database 181.

When storing the received data of the device already registered in the device management database 181, the device managing server 180 stores time information included in the received data thereof simultaneously. Thus, with the device managing server 180, processing in the time sequence can be performed at the time of performing data processing later.

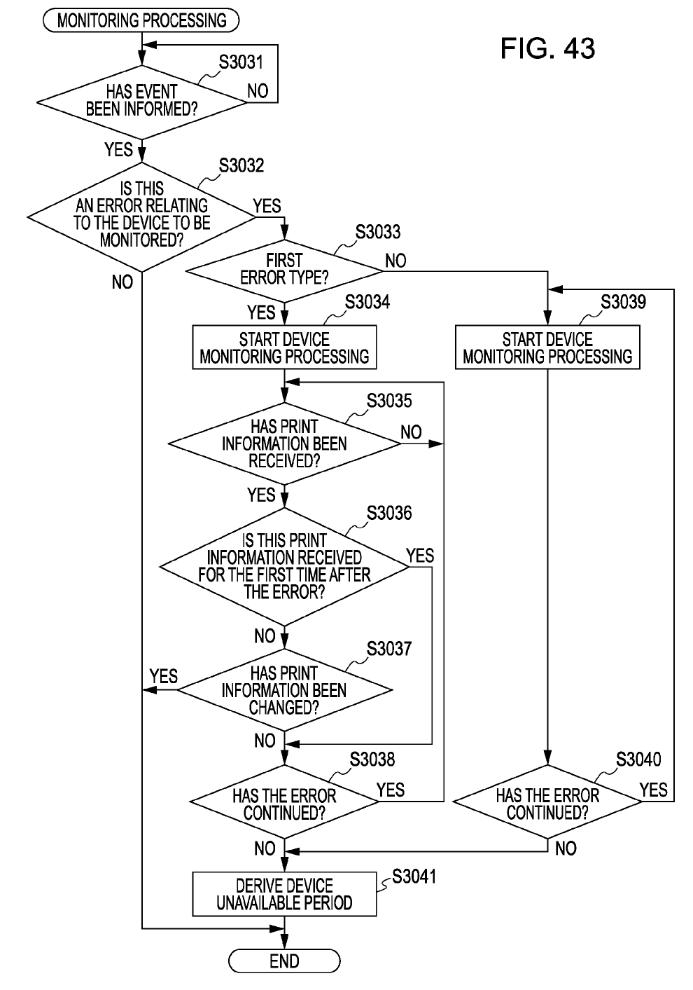

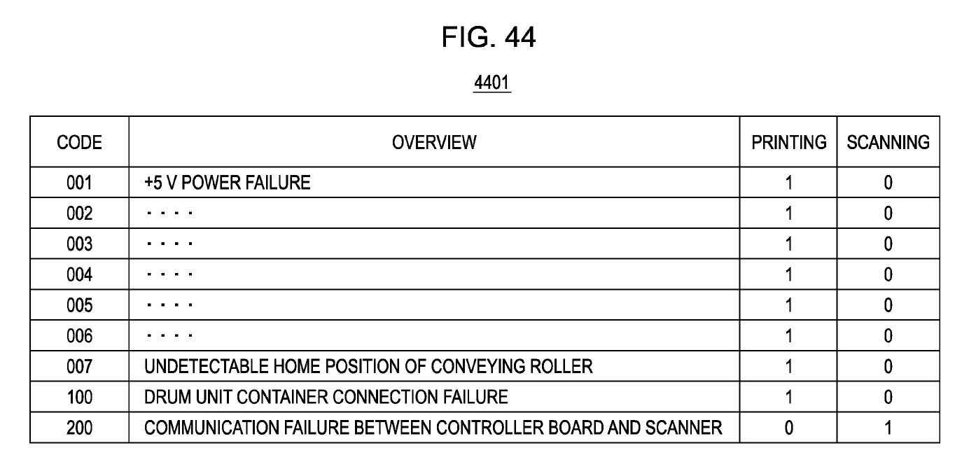

Next, description will be made with reference to FIGS. 43 through 46 regarding an example of a method for understanding a problem or state occurring at the devices 170 and 171 from the received information of the devices 170 and 171. FIG. 43 is a flowchart for describing an example of processing at the network system at the time of understanding a problem or state occurring at the devices 170 and 171. In step S3031, the device managing server 180 stands by until an event is informed from the devices 170 and 171. Upon an event having been informed, the processing proceeds to step S3032. Subsequently, the device managing server 180 determines whether or not the content of the informed event is an error of the devices 170 and 171 serving as monitoring targets. Specifically, the device managing sever 180 determines whether or not the content of the informed event is data recorded in an error monitoring target table 4401 stored in the device management database 181 (see FIG. 44). In a case wherein the content of the informed event has not recorded in the error monitoring target table 4401 as a result of this determination, the processing according to the flowchart shown in FIG. 43 ends. Also, in a case wherein the content of the informed event is an event of a device which is not a monitoring target as well, the processing according to the flowchart shown in FIG. 43 ends. As described above, with the present embodiment, an event informed from the devices 170 and 171 makes up at least a part of function execution information, and the processing in step S3031 is performed, thereby realizing an obtaining unit. Also, in a case wherein the content of an event is data recorded in the error monitoring target table 4401 stored in the device management database 181, information relating to a functional failure is realized with the data thereof.

The error monitoring target table 4401 shown in FIG. 44 is employed when device-unavailable information indicating a situation wherein the devices 170 and 171 cannot operate is generated. The device managing server 180 can modify, add, or eliminate the content of the error monitoring target table 4401 at the time of operation as necessary. In step S3032, in a case wherein the content of the informed event is an error of the devices 170 and 171 serving as monitoring targets, the processing proceeds to step S3033. In step S3033, the device managing server 180 determines whether or not the error type thereof is a first error type. In a case wherein the error type is not the first error type but a second error type as a result of this determination, the processing proceeds to later-described step S3039. On the other hand, in a case wherein the error type is the first error type, the processing proceeds to step S3034. The first error type is an error requiring no power-off operation of the devices 170 and 171.

Upon the processing proceeding to step S3034, the device managing server 180 starts device monitoring processing for determining the printing state of a device of which the error is continuing based on the information of the number of printed sheets. Next, in step S3035, the device managing server 180 stands by until printing information periodically transmitted from the devices 170, 171, or monitoring device 182 is received. This printing information includes the information of the number of printed sheets. Thus, with the present embodiment, information relating to the number of times for execution of the function is realized with the information of the number of printed sheets.

Upon the printing information having been received, the processing proceeds to step S3036. Subsequently, the device managing server 180 confirms whether or not the counter information exists in the device management database 181 to confirm whether or not the printing information is printing information received for the first time after occurrence of the error. In the case of the printing information received for the first time after occurrence of the error as a result of this determination, no printing information already received exists, so the processing skips step S3037, and proceeds to step S3038.

Upon the processing proceeding to step S3038, the device managing sever 180 determines whether or not the error of the device serving as a device monitoring processing target is continuing. In a case wherein no notice indicating that the error has been eliminated after the error was informed has been received, the device managing server 180 determines that the error of the device serving as a device monitoring processing target is continuing. In a case wherein that the error of the device serving as a device monitoring processing target is continuing as a result of this determination, the processing returns to step S3035, where the device managing server 180 stands by until the printing information is received. Note that though not shown in FIG. 43, notice indicating that the error of the device has been eliminated can be received at any timing. Accordingly, in a case wherein determination is made that the error of the device has been eliminated before step S3035 is executed, the device managing server 180 ends the processing according to the flowchart shown in FIG. 43 at the point of time thereof.

In a case wherein determination is made in step S3036 that the printing information is not printing information received for the first time after occurrence of the error, the processing proceeds to step S3037. Subsequently, the device managing sever 180 determines whether or not the printing information received this time has been changed from the printing information already received. This determination is for confirming whether or not printing itself has been performed.

In a case wherein as a result of this determination the printing information received this time has been changed from the printing information already received, i.e., the printing information has been updated, and the device managing server 180 stores the updated printing information in the device management database 181. Subsequently, the processing according to the flowchart shown in FIG. 43 ends. On the other hand, in a case wherein the printing information received this time has not been changed from the printing information already received, the processing proceeds to the above-mentioned step S3038, where the device monitoring processing is continued while the error of the device is continuing.

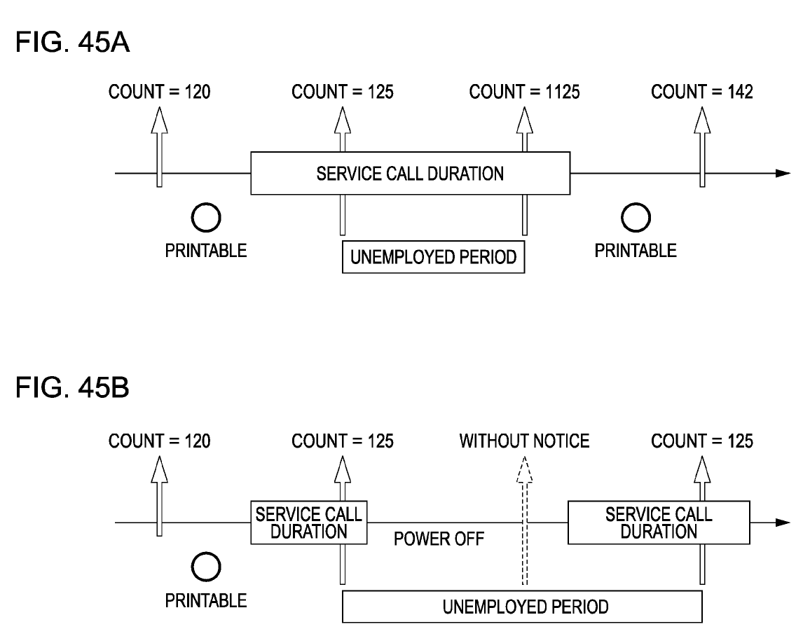

FIGS. 45A and 45B are diagrams conceptually illustrating an example of the device monitoring processing in the case of an error of the first error type occurring at the device (steps S3034 through S3038). In FIGS. 45A and 45B, upward arrows mean printing information periodically transmitted from the devices 170, 171, or monitoring device 182. Note that in FIGS. 45A and 45B, this printing information is represented as COUNT.

Upon a service call which is an error example occurring, the device managing server 180 is informed of failure information. The device managing server 180 starts device monitoring processing, based on the failure information thereof, in the case of an error of the monitoring target devices 170 and 171. In a case wherein the number of printing information (number of printed sheets) periodically received during a service call (error) continuing (service call duration) increases beyond the number of printing information (number of printed sheets) already received, this means that printing has been performed regardless of occurrence of the service call (error).

On the other hand, in a case wherein the number of printing information (number of printed sheets) periodically received during the service call duration is identical to the number of printing information (number of printed sheets) already received, this means that the device has not been employed. If the service call duration is overlapped with a license use period, this can be regarded as the device being unavailable for the user due to the error. In this case, there may be a case wherein the user refrains from use due to the error occurring, or a case wherein the device is actually in an unprintable state.

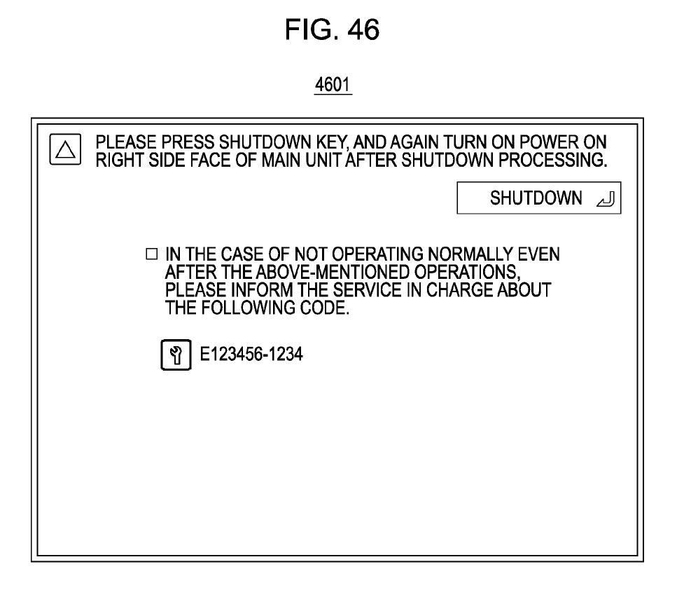

Now, let us return to the description of FIG. 43. In a case wherein determination is made in step S3033 that the error type is not the first error type but second error type, the processing proceeds to step S3039. The second error type means an error necessary for displaying a power-off request screen 4601 for requesting power-off of the devices 170 and 171 on the devices 170 and 171 (see FIG. 46). This second error type is an error for preventing the user from using the devices 170 and 171, such as a component failure within the devices 170 and 171, or the like. In the case of an error of the second error type occurring, printing is not performed. Accordingly, in the case of an error of the second error type occurring, the processing such as comparison of printing information in steps S3035 through S3037 is not performed. As described above, with the present embodiment, the processing in steps S3032 and S3033 is performed, thereby realizing a determining unit.

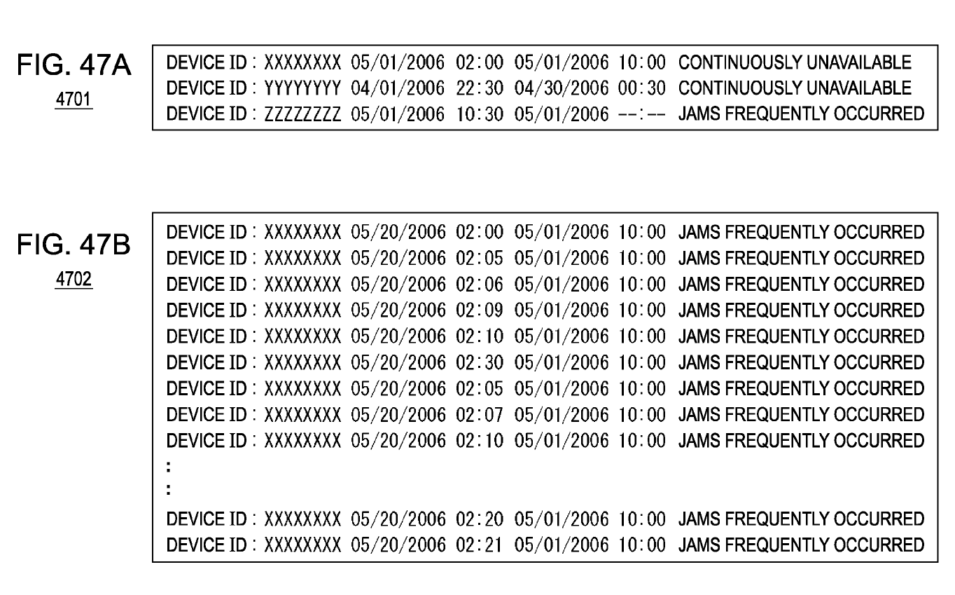

In step S3039, the device managing server 180 starts device monitoring processing. Next, in step S3040, the device managing server 180 determines whether or not the error of the device serving as a device monitoring processing target is continuing. In the case of receiving no notice indicating that the error has been eliminated after the error was informed, the device managing server 180 determines that the error of the device serving as a device monitoring processing target is continuing. As described above, in a case wherein the error of the device serving as a device monitoring processing target has been eliminated in steps S3038 and S3040, the processing proceeds to step S3041. Upon the processing proceeding to step S3041, the device managing server 180 derives duration wherein the device serving as a device monitoring processing target cannot be used (unavailable duration). Also, the device managing server 180 generates device-unavailable information such as shown in FIGS. 47A and 47B. As described above, with the present embodiment, information relating to a period wherein the function cannot be executed correctly is realized by notice indicating that the error has been eliminated, which is transmitted from the devices 170 and 171.

Note that if the error has not been eliminated even in the case of the power of the device being turned off for a certain of period, the same processing as the flowchart shown in FIG. 43 can be performed. FIG. 45B illustrates a case wherein a service call (error) occurs, and the user turns off the power as an example. In this case, with the flowchart shown in FIG. 43, printing information is not received. The device managing server 180 compares the received date and point-in-time of the printing information received immediately before the power is turned off, with the received date and point-in-time of the printing information received for the first time after the power is turned on again. Subsequently, based on the comparison results, the device managing server 180 can understand a period wherein printing information (the number of printed sheets) does not increase regardless of a period wherein printing information cannot be obtained. In this case, a period wherein the error occurs at the devices 170 and 171 becomes intermittent, but the user cannot use the devices 170 and 171 continuously during this period.

Note that the processing according to the flowchart shown in FIG. 43 can be performed in real time, but this processing can be applied to the data already registered in the device management database 181. This is because that, as described above, the time information is included in the received data, so the received data can be rearranged in the time sequence.

FIGS. 47A and 47B are diagrams illustrating an example of device unavailable information. FIG. 47A is a diagram illustrating an example of device unavailable duration information for specifying device unavailable duration (during which the device cannot be used). Device-unavailable information 4701 shown in FIG. 47A includes a device ID for specifying a device, the start date and time of the device unavailable duration of the device thereof, the end date and time of the device unavailable duration of the device thereof, and the state of the device thereof (phenomenon occurring).

FIG. 47B is a diagram illustrating an example of the information of a device in a state regarding which determination has made that the user will experience a considerable amount of trouble due to problems such as frequent occurrence of errors in a short period of time at the same device, paper conveyance error, or the like, even though the level of trouble has not reached that of the device becoming unusable. This information is also referred to as device-unavailable information here. Device-unavailable information 4702 shown in FIG. 47B indicates that jamming frequently occurs during a short period of time. In this case, even if the number of printed sheets increases, not only there is a possibility that sheets are employed wastefully, but also there is a possibility that the user is using a considerable amount of time over jams frequently occurring, since recovery from a jam is not automatic. Processing in the case of employing the device-unavailable information 4702 shown in FIG. 47B will be described at later-described license compensation determination processing.

The device-unavailable information 4701 shown in FIG. 47A is created with a text file by the device managing server 180, and is stored, for example, in the device management database 181. The license information issuance server 101 can obtain the device-unavailable information 4701 as necessary. With the devices 170 and 171 managed by the device managing server 180, if no error occurs at all, the file itself of the device-unavailable information 4701 is not generated. At the time obtaining data indicating that the license information issuance server 101 can understand that there is no device serving as a license compensation target.

It can be readily understood by referencing such device-unavailable information 4701 and 4702 that which device was unavailable during which period by what kind of reason. Note that any timing may be employed for generating the files of the device-unavailable information 4701 and 4702. Also, describing “error continuing” in the column of events of occurrence makes it possible to represent that the error is continuing at the present moment, and an unavailable state is continuing. Also, the device-unavailable information 4701 and 4702 shown in FIGS. 47A and 47B may be generated at a later date based on the information stored in the device management database 181.

The license information issuance server 101 can perform, for example, the following processing using the device-unavailable information 4701 and 4702. The license information issuance server 101 manages the ID (device ID) of a device to which a license has been provided. Accordingly, the license information issuance server 101 can determine a unique device, and can understand whether or not a trouble occurs during a license valid period by obtaining the device-unavailable information 4701 and 4702 from the device managing server 180.

For example, in order to confirm what kind of operation state the device to which a license “ABC00001” serving as a device ID has been provided is, the license information issuance server 101 performs the following processing. The license information issuance server 101 accesses the device managing server 180 through the network 105.

The device managing server 180 can provide access restrictions using a device ID and password, or can provide restrictions from the license information issuance server 101 using the IP address of the license information issuance server 101 from the perspective of security. The device managing server 180 can generate the device-unavailable information 4701 and 4702 in accordance with the request of the license information issuance server 101. Also, the device managing server 180 can generate the device-unavailable information 4701 and 4702 beforehand. Also, in response to the access of the license information issuance server 101, the device managing server 180 can generate the newest device-unavailable information 4701 and 4702 on the spot. Thus, the license information issuance server 101 can obtain the device-unavailable information 4701 and 4702 regarding the devices 170 and 171 managed by the device managing server 180.

### License Compensation Determination Processing at License Information Issuance Server 101

In order to determine whether or not an already provided license needs to be compensated based on the received device-unavailable information 4701 and 4702, the license information issuance server 101 performs, for example, the following processing. The reason why determination is made whether or not a license needs to be compensated is that an available license on a permanent basis does not need to be compensated.

Note that determination can be made automatically regarding the necessity of license compensation, but determination can also be made manually. Whether the necessity of license compensation is determined automatically or manually can be determined based on the information fixedly held in the license information management database 106. Also, this can be selected on a screen by an application. Additionally, it can also be conceived to process a particular error as a target to be compensated automatically.

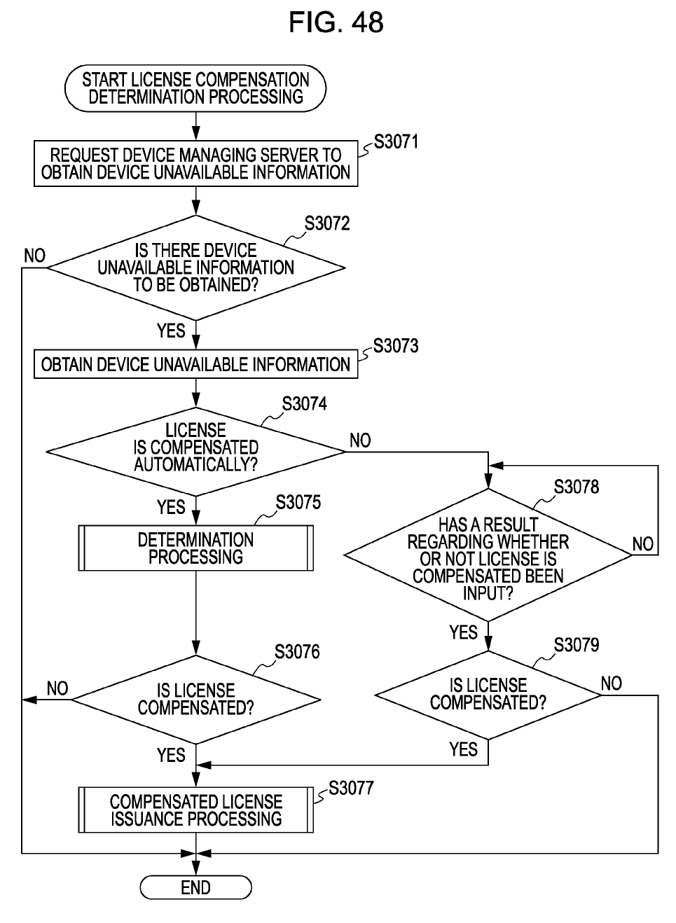

FIG. 48 is a flowchart for describing an example of processing at the network system at the time of determining license compensation. In step S3071, the license information issuance server 101 requests the device managing server 180 to obtain the device-unavailable information 4701 and 4702. In step S3072, the license information issuance server 101 determines whether or not the device-unavailable information 4701 and 4702 to be obtained exists in the device managing server 180. The device-unavailable information 4701 and 4702 to be obtained means the device-unavailable information 4701 and 4702 at the device to which the function of the license is provided.

In a case wherein the device-unavailable information 4701 and 4702 to be obtained does not exist in the device managing server 180 as a result of this determination, the processing according to the flowchart shown in FIG. 48 ends. In this case, as long as the device managing server 180 references the information obtained from the devices 170 and 171, there is no need to compensate a provided license. Note that at this time, if processing is performed such that the device information that the license information issuance server 101 intends to reference is provided to the device managing server 180 beforehand or the like, the license information issuance server 101 does not need to obtain the data unnecessarily.

On the other hand, in a case wherein determination is made in step S3072 that the device-unavailable information 4701 and 4702 to be obtained exists in the device managing server 180, the processing proceeds to step S3073. Subsequently, the license information issuance server 101 obtains the device-unavailable information 4701 and 4702 from the device managing server 180.

Next, in step S3074, the license information issuance server 101 determines whether the license is to be compensated manually by the user, or automatically. This determination may be fixed or variable on the system. In the case of determining to be variable, for example, a flag of the license information management database 106 needs to be rewritten depending on a situation.

In the case of compensating the license manually as a result of this determination, the processing proceeds to later-described step S3078. On the other hand, in the case of compensating the license automatically, the processing proceeds to step S3075, where the license information issuance server 101 performs determination processing. As for a determining method in step S3705, with the present embodiment, for example, the following method may be employed.

(1) If the license is within the license application period, a compensated license is issued. The license information issuance server 101 performs, for example, prior notification to the effect that “The license can be extended for three days. Please register a new license file,” as to the user terminal 102. Subsequently, when receiving a license update request from the user terminal 102, the license information issuance server 101 adds necessary number of dates and sheets, and issues a license. At this time, the license information issuance server 101 diverts the unavailable period obtained from the unavailable information without change. For example, in a case wherein the unavailable period obtained from the unavailable information is three days (in a case wherein the devices 170 and 171 cannot be used for three days), it can be conceived that the license information issuance server 101 automatically extends the license for three days, thereby compensating the license.

(2) In a case wherein the license application period has already been expired, a license is issued newly free of charge. In a case wherein the license has already exceeded the license use period or available restrictions, the license information issuance server 101 issues an unavailable period worth of license, or available restrictions worth of license to the user terminal 102, free of charge.

In addition to the above-mentioned (1) and (2), the following determination may be made.

(3) In a case wherein the devices 170 and 171 are not unavailable, the license information issuance server 101 issues a uniform number of licenses for a uniform period to the user terminal 102 free of charge, thereby compensating the license.
(4) The license information issuance server 101 sets a threshold serving as a determination reference value regarding whether or not license compensation is applied, and only in the case of exceeding the threshold, compensates the license. As for the threshold, for example, five days or more may be set. For example, with the method of (1), in a case wherein a particular error has continued for several days, and in the meantime no printing has been performed, license compensation may be performed. Also, in a case wherein the license cannot be used the number of dates exceeding 10% of the license application period, license compensation may be performed. With regard to a license compensation method as well, various compensation methods can be conceived, such that the number of dates and time provided during the device unavailable period are employed as a extended period without change, a uniform 100 sheets of printing is provided as a service without changing the license application period, and so forth.

As described above, there are various types of license compensation methods, but description will be made below regarding a method for compensating the license by applying the unavailable period obtained from the device-unavailable information 4701 and 4702 as an example.

Note that the determination result in step S3074 may be displayed on the screen to prompt the user to confirm this. Also, in the case of displaying the determination result in step S3074 on the screen to compensate the license manually, correspondence may be performed on this screen, such as eliminating compensation itself, or the like.

The determination processing in step S3075 ends, and upon the processing proceeding to step S3076, the license information issuance server 101 determines whether to compensate the license based on the determination processing result in step S3075. In a case wherein the license is not compensated as the determination result, the processing according to the flowchart shown in FIG. 48 ends. On the other hand, in the case of compensating the license, the processing proceeds to step S3077, the license information issuance server 101 performs compensated license issuance processing, issues the compensated license, and the processing according to the flowchart shown in FIG. 48 ends.

With the compensated license issuance processing, the license information issuance server 101 issues the compensated license based on the compensation issuance conditions. Thus, the license information issuance server 101 can issue the compensated license with the following method. That is to say, compensation issuance conditions such as an extended period are added to the license issuance processing for issuing a new license (see FIGS. 28 and 29), whereby the compensated license can be issued. As described above, with the present embodiment, the processing in step S3077 is executed, thereby realizing a compensating unit.

In a case wherein determination is made that the license is to be compensated manually in step S3074, the processing proceeds to step S3078. The operator determines whether or not the license is to be compensated based on the device-unavailable information 4701 and 4702 received from the device managing server 180, and inputs the determination result to the license information issuance server 101. For example, in a case wherein the user is to fault, and the devices 170 and 171 cannot be used due to the user's actions, the operator determines that the license does not need to be compensated. Examples of a case wherein the devices 170 and 171 cannot be used wherein the user is faulted include a case of the user printing on banned sheets, resulting in the drum being damaged, and so forth.

Also, for example, the actual unavailable period is three days, but in the case of a state wherein the devices 170 and 171 cannot be used for a long period, due to no fault of the user, the operator determines that the license needs to be compensated. Examples of the case of a state wherein the devices 170 and 171 cannot be used for a long period being caused due to no fault of the user include a case wherein a distribution source is delinquent in delivering parts. Such cases can be flexibly handled, such as the license being compensated one or two days longer than the actual unavailable period, to make up for the inconvenience to the user.

In step S3708, the device managing server 180 stands by until the determination result thus performed by the operator is input. Upon the determination result performed by the operator having been input, the processing proceeds to step S3079. Subsequently, the device managing server 180 determines whether or not the license is to be compensated based on the input content. In a case wherein the license is to be compensated as the determination result, the processing proceeds to the above-mentioned step S3077, the license information issuance server 101 performs compensated license issuance processing, and the processing according to the flowchart shown in FIG. 48 ends. On the other hand, in a case wherein the license is not to be compensated, the processing according to the flowchart shown in FIG. 48 ends.

Even if the devices 170 and 171 are not unavailable, for example, if errors are frequently caused such that sheets are damaged or only a part thereof are printed due to jamming, an undesirable state for the user is caused due to frequent jamming, such as recovery efforts, and waste of sheets. Thus, there is a possibility that the user may be disadvantaged. Therefore, with the present embodiment, like the above-mentioned method (4), even if the devices 170 and 171 are not unavailable, the license may be compensated.

As described above, the device managing server 180 can generate, as shown in FIG. 47B, the device-unavailable information 4072 in the case of errors frequently occurring. Accordingly, an arrangement is made wherein, like the device-unavailable information 4702, even in a case wherein information serving as a compensation target is not included, the device managing server 180 can compensate a license.

With such an arrangement, when not reaching unavailable determination with the device-unavailable information 4072, the device managing server 180 performs compensation of the license in a service manner in accordance with the determination based on the error occurrence information collected at normal monitoring. The determination of this case can be performed, for example, by providing a certain condition (e.g., threshold), and determining whether or not the certain condition thereof is satisfied. For example, it can be conceived to perform such license compensation in a case wherein a state in which the devices 170 and 171 cannot be used is continuing during recovery work time or activation time not less than a certain period of time (e.g., several minutes), or the like. Specifically, such license compensation can be performed, for example, in a case wherein a paper jam has been detected not less than five times within a certain period of time (e.g., one hour), in a case wherein power on/off errors have occurred not less than twice within a certain period of time, or the like. Such determination can be performed, for example, after determining that the license has not been compensated in steps S3076 and S3079 in FIG. 48. In the case of compensating the license, license compensation can be readily realized by executing the compensated license issuance processing in step S3077.

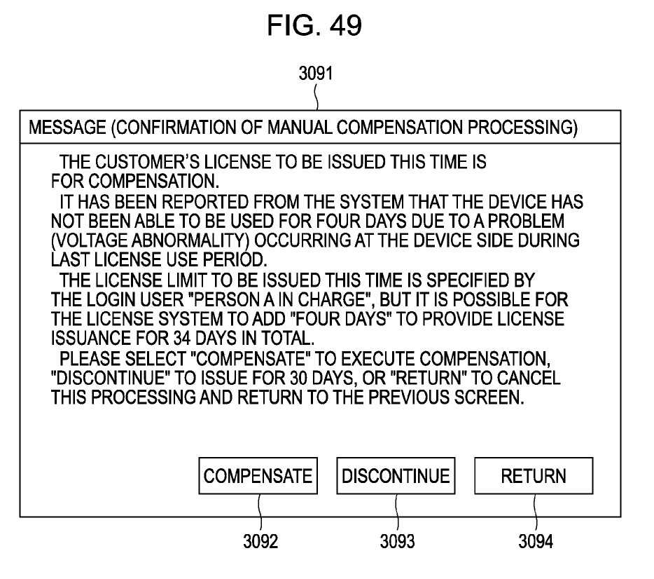

FIG. 49 is a diagram illustrating an example of a screen 3091 displayed on the seller terminal 103 at the time of determining manually whether or not the operator of the sales company compensates the license. The operator of the sales company references this screen 3091, whereby the content of compensation can be confirmed, and execution of compensation can be determined. Upon a “Compensate” button 3092 having been selected, for example, by the operator of the sales company, the processing is performed in order of steps S3078, S3079, and S3077, thereby compensating the license. On the other hand, upon a “Discontinue” button 3093 having been selected, for example, by the operator of the sales company, the license compensation is cancelled (No is determined in step S3079). For example, in a case wherein the devices 170 and 171 are down due to the impossible use or erroneous operations of the user, the operator of the sales company determines that license compensation is unsuitable, and selects the “Discontinue” button 3093. Also, upon a “Return” button 3094 having been selected, the screen returns to the previous screen of the license issuance processing, whereby the license conditions can be modified.

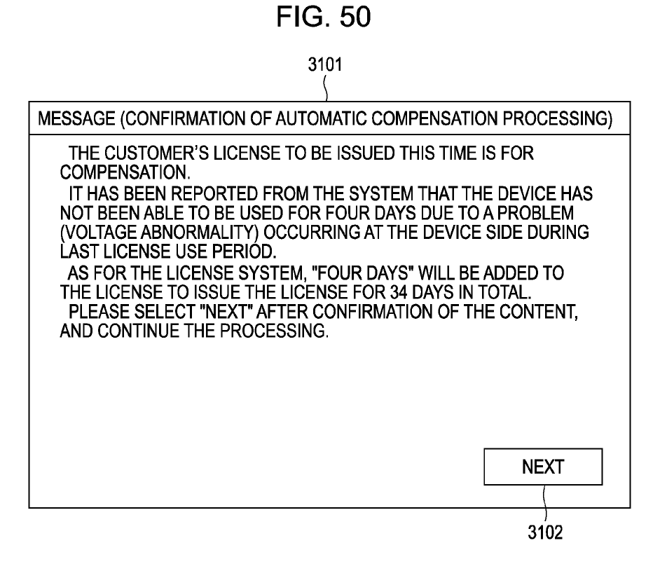

FIG. 50 is a diagram illustrating an example of a screen 3101 to be displayed on the seller terminal 103 at the time of determining automatically whether or not the license is to be compensated. The operator of the sales company can confirm the content of compensation by referencing the screen 3101. However, the operator of the sales company cannot perform cancellation of license compensation or the like. Upon the operator of the sales company having selecting a “Next” button 3102, the compensated license issuance processing in step S3077 is executed.

In the case of the license being compensated (updated) as described above, the user needs to know this to obtain advantage by the license being compensated. Therefore, with the present embodiment, for example, an arrangement is made wherein when the compensated license is issued, or following the compensated license being issued, information regarding compensation is provided from the license information issuance server 101 to the user terminal 102, for example, by e-mail.

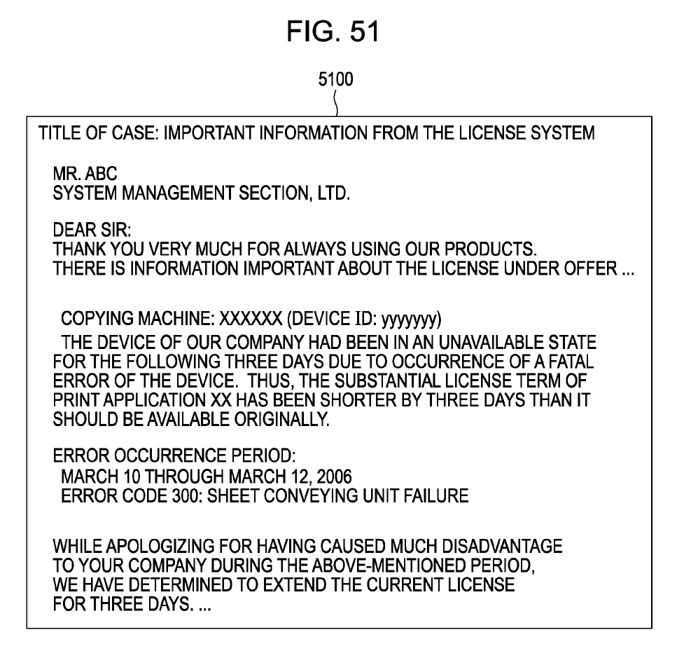

FIG. 51 is a diagram illustrating an example of the content of an e-mail for informing the user that the license has been compensated. According to this mail 5100, the user can be informed of extension of the license available period. Also, according to this mail 5100, at the time of updating the license the user can be prompted to purchase or issue a conditional license wherein the loss has been compensated for. Also, the user is informed of extension of the license, whereby the user can receive the benefit by the license having been compensated without holding the misconception that the function based on the license cannot be used during the extended period. Note that whether or not the user is informed of the license having been compensated may be selected.

As described above, with the present embodiment, in a case wherein there has been an error regarding the devices 170 and 171, the device managing server 180 generates device-unavailable information 4701 and 4702 including the operation statuses of the devices 170 and 171 during a period wherein the devices 170 and 171 cannot be used. In the case of determining that the devices 170 and 171 cannot be used based on the device unavailable information 4701 and 4702 regarding which the user cannot be faulted, the license information issuance server 101 obtains the compensation worth of the license. Subsequently, the license information issuance server 101 issues the license wherein the obtained compensation worth has been compensated to the user terminal 102. Accordingly, in a case wherein the function realized at the devices 170 and 171 by the license being provided cannot be realized regarding which the user cannot be faulted, the license as to the function thereof can be readily compensated in a sure manner as compared with the related art.

Note that with the present embodiment, an arrangement has been made wherein the device unavailable information 4701 and 4702 are transmitted from the device managing sever 180 to the license information issuance server 101, and subsequently, the license information issuance server 101 manages the compensation worth of the license (e.g., the extended period or additional number of prints of the license) based on the device unavailable information 4701 and 4702. However, there is necessarily no need to follow this arrangement. For example, an arrangement may be made wherein the device managing server 180 generates the information of the compensation worth of the license based on the device unavailable information 4701 and 4702, and transmits the generated information to the license information issuance server 101. Thus, the license information issuance server 101 needs to manage only the license information, whereby the load of the license information issuance server 101 can be reduced. Also, with the present embodiment, an arrangement has been made wherein the license information issuance server 101 and device managing server 180 are provided at separate places as separate devices, but these may be configured as a single server device.

Also, with the present embodiment, an arrangement has been made wherein license compensation is performed at an opportunity independent from the update time of a license, but a new license may be issued wherein the compensation worth is added at the time of updating a license. For example, the license information issuance server 101 stores information relating to compensation, and subsequently, upon receiving a request for license issuance or request for license continuation from the user, the license information issuance server 101 issues a license newly by adding the stored compensation information thereto. Specifically, upon the requesting license issuance of which the valid period is 30 days, the license information issuance server 101 issues a license of which the license application period is a total of 35 days by adding an unavailable period (five days) wherein the device could not be used to the original valid period.

Also, the network 105 may be any of the Internet, phone line, private line, and so forth, and the method of the network 105 is not restricted to particular one. Also, with the present embodiment, data passing with a file has been employed, but data passing with a protocol may be employed. Also, data may be passed with a portable-type recording medium (removable recording medium) or the like. Also, examples of a recording medium for supplying the unavailable information include a flexible disk, hard disk, optical disc, magneto-optical disk, MO, CD-ROM, CD-R, CD-RW, magnetic tape, nonvolatile memory card, ROM, and DVD (DVD-ROM, DVD-R), and so forth.

### Second Embodiment

Next, the second embodiment of the present invention will be described. With the above-mentioned first embodiment, the case wherein one piece of software having a license to be compensated is installed or purchased as to one device has been described as an example. Correspondingly, with the present embodiment, a case wherein a plurality of software programs having a license to be compensated are installed or purchased as to one device will be described as an example. Thus, the principal difference between the present embodiment and the above-mentioned first embodiment is the number of licenses to be compensated as to one device. Accordingly, with the description of the present embodiment, the same portions as those in the above-mentioned first embodiment will be denoted with the same reference numerals as those denoted in FIGS. 1 through 51, and detailed description will be omitted.

The printing information collected by the device managing server 180 is defined originally as the operation information of the devices 170 and 171. Accordingly, in a case wherein a plurality of software having a license to be compensated are installed in one device, there is no arrangement to determine which software program has been involved in the printing operation or scanning operation. Accordingly, it is difficult to control license compensation in increments of software, but license compensation may be performed in increments of particular groups.

For example, in a case wherein the count value of a counter indicating the total number of printed sheets has not been incremented at all during a period wherein an error is continuing, this means that none of the software having a printing function can be used. Therefore, the license information issuance server 101 can apply compensation to all of the software having a license corresponding to a printing function. Also, in a case wherein there has been no printing function use history, and there has been a scanning function use history, compensation may be applied only to the software having a license not employing a scanner.

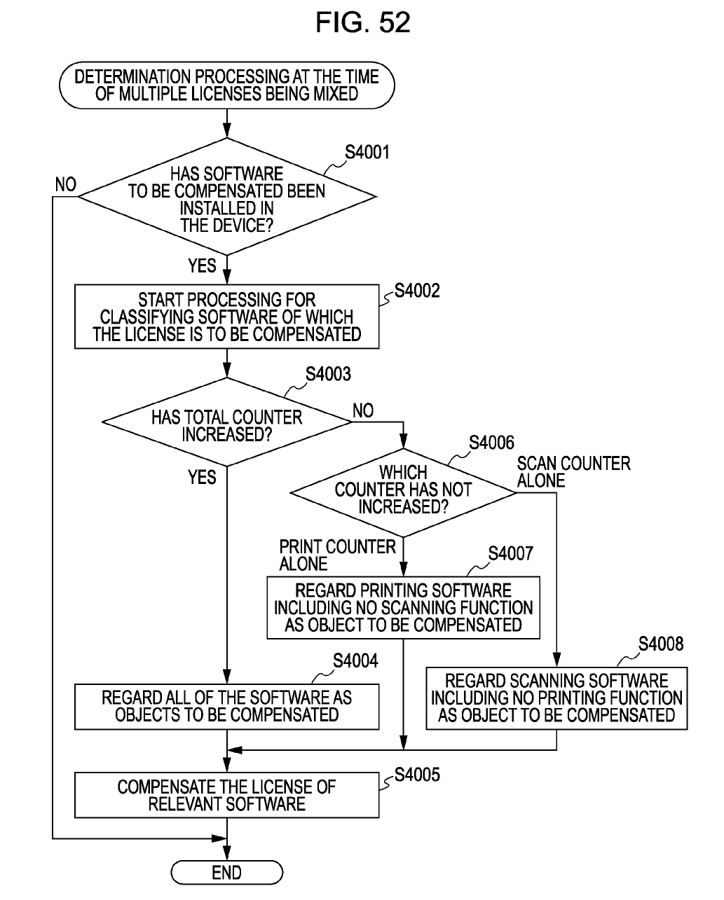

FIG. 52 is a flowchart for describing an example of processing for handling such a situation. In step S4001, the license information issuance server 101 determines at the time of compensation processing of a license whether or not software (function) having a license to be compensated is installed in the devices 170 and 171. Note that whether or not software (function) having a license to be compensated is installed in the devices 170 and 171 is determined beforehand by the sales company for selling licenses. As a result of the determination, in a case wherein software (function) having a license to be compensated is not installed in the devices 170 and 171, for example, in a case wherein determination is made that the support period has ended, and the license is not a compensation target, the processing according to FIG. 52 ends.

On the other hand, in a case wherein software (function) having a license to be compensated is installed in the devices 170 and 171, the processing proceeds to step S4002. Subsequently, the license information issuance server 101 starts processing for classifying software of which the license is to be compensated. Next, in step S4003, the license information issuance server 101 determines whether or not the total value of the counter transmitted from the devices 170 and 171 has been incremented.

As a result of this determination, in a case wherein the total value (including the value of the counter for counting scanning) of the counter has not increased, the processing proceeds to step S4004. Subsequently, the license information issuance server 101 determines that the function of the devices 170 and 171 has not been used, and compensation is performed as to the licenses of all of the software. Subsequently, the processing proceeds to step S4005, where the license information issuance server 101 compensates the licenses of all of the software.

In a case wherein the total value of the counter has increased in step S4003, determination is made that a part of the software has been used, and the processing proceeds to step S4006. Subsequently, the license information issuance server 101 confirms the content of the counter of which the value has increased. As a result thereof, in a case wherein the value of the counter for counting printing has not increased, the processing proceeds to step S4007, and in a case wherein the value of the counter for counting scanning has not increased, the processing proceeds to step S4008. Upon the processing proceeding to step S4007, the license information issuance server 101 determines that the printing function has not been used, and performs compensation to the licenses of the printing software. Subsequently, the processing proceeds to step S4005, where the license information issuance server 101 compensates the licenses of the printing software. On the other hand, upon the processing proceeding to step S4008, the license information issuance server 101 determines that the scanning function has not been used, and performs compensation to the licenses of the scanning software. Subsequently, the processing proceeds to step S4005, where the license information issuance server 101 compensates the licenses of the scanning software. As described above, with the present embodiment, the processing in steps S4003 through S4008 is executed, thereby executing a determining unit.

Note that the license information issuance server 101 can understand regarding what kind of function each software has. Therefore, as described above, the software having a license to be compensated can be determined. Also, the conditions and combinations of compensation can flexibly be defined at the license information issuance server 101. As described above, with the present embodiment, a license can be compensated (license compensation can be classified) in increments of the function of software having a license.

### OTHER EMBODIMENTS OF PRESENT INVENTION

The respective units making up the license management system, and the respective steps of the license management method, according to the above-mentioned embodiments of the present invention can be realized by running a program stored in the RAM or ROM or the like of the computer. This program and the above-mentioned computer-readable recording medium in which the program is recorded are encompassed in the present invention.

Also, with the present invention, an embodiment serving as a system, device, method, program, recording medium, or the like may be employed, for example, and specifically, the present invention may be applied to a system made up of multiple apparatuses, or may be applied to equipment made up of a single apparatus.

Note that the software program for realizing the functions of the embodiments (e.g., programs corresponding to the flowcharts shown in FIGS. 18, 19, 25, 27 through 30, 38, 43, 48, and 52) may be directly supplied to a system or device, or supplied remotely. Additionally, a case wherein the functions of the embodiments are achieved by the computer of the system or device thereof reading out and executing the above-mentioned supplied program code is also encompassed in the present invention.

Accordingly, the program code itself to be installed in the above-mentioned computer also realizes the present invention to realize the function processing of the present invention by the computer. That is to say, a computer program itself for realizing the function processing of the present invention is also encompassed in the prevent invention.

In this case, the computer program may be provided with any mode such as object code, program executed by interpreter, script data supplied to the OS, or the like as long as this has a program function.

Examples of a recording medium for supplying the program include a floppy disk, hard disk, optical disc, magneto-optical disk, MO, CD-ROM, CD-R, and CD-RW. Also, magnetic tape, nonvolatile memory card, ROM, DVD (DVD-ROM, DVD-R), and so forth, may be employed.

Also, as for a program supply method, an arrangement may be made wherein a browser of a client computer is employed to connect to a homepage on the Internet, and subsequently, the computer program itself of the present invention or a file compressed including an automatic install function is downloaded to a recording medium such as a hard disk or the like from the above-mentioned homepage, whereby the program can be supplied.

Also, an arrangement may be made wherein the program code making up the program of the present invention is divided into multiple files, and the respective files are downloaded from different homepages, whereby the function processing of the present invention can be realized. That is to say, a WWW server for allowing multiple users to download the program file for realizing the function processing of the present invention at a computer is also encompassed in the present invention.

Also, an arrangement may be made wherein the program of the present invention is encrypted, stored in a recording medium such as CD-ROM or the like, and distributed to users, and a user who satisfies predetermined conditions is allowed to download key information for decryption from a homepage through the Internet, and subsequently, the encrypted program is executed by employing the downloaded key information to be installed in a computer, thereby realizing the function processing of the present invention.

Also, the computer executes the read program, thereby realizing the functions of the above-mentioned embodiments. Additionally, the OS or the like operating on the computer may perform a part or all of the actual processing based on the instructions of the program thereof, whereby the functions of the above-mentioned embodiments can also be realized by the processing thereof.

Further, an arrangement may be made wherein the program read out from a recording medium is written in the memory provided in a functional expansion board inserted in the computer or functional expansion unit connected to the computer, and subsequently, the CPU or the like provided in the functional expansion board or functional expansion unit performs a part or all of the actual processing based on the instructions of the program thereof, whereby the functions of the above-mentioned embodiments can also be realized by the processing thereof.

Note that the above-mentioned respective embodiments simply show specific examples of implementation of the present invention, and the technical scope of the present invention is not to be interpreted thereby restrictively. That is to say, the present invention can be implemented in various forms without departing from the technical idea or principal features thereof.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-201213 filed Aug. 1, 2007, which is hereby incorporated by reference herein in its entirety.

What is claimed is:

1. A license management system for managing license information to execute a function of an electronic device, comprising:
an issuing unit configured to issue license information as to a function executed by the electronic device to the electronic device;
an obtaining unit configured to obtain function execution information indicating an execution state of the function of the electronic device; and
a compensating unit configured to execute, based on the function execution information, processing for compensating the license information of the function of which the execution state is indicated with the function execution information.

2. The license management system according to claim 1, further comprising:
a determining unit configured to determine, based on the function execution information, whether the function of which the execution state is indicated with the function execution information is executed correctly,
wherein the compensating unit executes processing for compensating the license information of the function if the determining unit determines that the function is not executed correctly.

3. The license management system according to claim 1, wherein the function execution information includes at least any one of information relating to a number of times of execution of the function, information relating to a failure type of the function, and information relating to a period in which the function has not been executed correctly.

4. The license management system according to claim 1, further comprising:
a distinguishing unit configured to distinguish, based on the function execution information, the function of which the execution state is indicated with the function execution information,
wherein the compensating unit executes processing for compensating the license information of the function distinguished by the distinguishing unit.

5. A method for managing license information to execute a function of an electronic device, the method comprising:
issuing, to the electronic device license, information as to a function executed by the electronic device;
obtaining function execution information indicating an execution state of the function of the electronic device; and
executing, based on the function execution information, processing for compensating the license information of the function of which the execution state is indicated with the function execution information.

6. The method according to claim 5, further comprising:
determining, based on the function execution information, whether the function, of which the execution state is indicated in the function execution information, is being executed correctly,
wherein the processing for compensating the license information of the function occurs if it is determined that the function is not executed correctly.

7. The method according to claim 5, wherein the function execution information includes at least any one of information relating to a number of times of execution of the function, information relating to a failure type of the function, and information relating to a period in which the function is not executed correctly.

8. The method according to claim 5, further comprising:
distinguishing, based on the function execution information, the function of which the execution state is indicated with the function execution information,
wherein processing is performed for compensating the license information of the distinguished function.

9. A computer-readable recording medium storing a program arranged to cause a computer to execute the method according to claim 5.
